(19) United States
(12) Patent Application Publication
(10) Pub. No.: US 2025/0376398 A1
(43) Pub. Date: Dec. 11, 2025

(54) METHODS AND APPARATUS FOR TREATING CONTAMINANT IN A FLUID

(71) Applicant: Invicta Water, Inc., Cary, NC (US)

(72) Inventors: Jason Edward TAYLOR, Cary, NC (US); Mark EDMOND, Raleigh, NC (US)

(73) Assignee: Invicta Water, Inc., Cary, NC (US)

(21) Appl. No.: 18/776,129

(22) Filed: Jul. 17, 2024

Related U.S. Application Data
(60) Provisional application No. 63/656,447, filed on Jun. 5, 2024.

(51) Int. Cl. C02F 9/00; B01D 3/14; C02F 1/04; C02F 1/32; C02F 1/72; C02F 101/36

(52) U.S. Cl. CPC C02F 9/00; B01D 3/143; C02F 1/04; C02F 1/325; C02F 1/725; C02F 2101/36; C02F 2301/046; C02F 2301/08; C02F 2305/10

(57) ABSTRACT

Systems for treating contaminant in a fluid, the system comprising a contaminant concentration sub-stage and a PCD sub-stage. The contaminant concentration sub-stage is configured to receive a fluid supply comprising a contaminant, and to output (1) from a first outlet a first portion comprising a first concentration of the contaminant, and (2) from a second outlet a second portion comprising a second concentration of the contaminant, the first concentration greater than the second concentration. The PCD sub-stage comprises a PCD vessel and a PCD photocatalyst that is in the PCD vessel. The first outlet of the contaminant concentration sub-stage is fluid-flow connected to an inlet of the PCD vessel. Also, multistage systems comprising one or more contaminant concentration sub-stages and one or more PCD sub-stages. Also methods of treating contaminant in a fluid.

### CROSS-REFERENCE TO A RELATED APPLICATION

This application claims the benefit under 35 U.S.C. 119 section (e) of U.S. Provisional Patent Application No. 63/656,447, filed Jun. 5, 2024, the entirety of which is incorporated herein by reference.

### FIELD OF THE INVENTION

The present invention relates to methods of treating contaminant in fluids, and apparatus for use in treating contaminant in fluids. In some aspects, the present invention relates to methods of treating contaminants in water (e.g., PFAS in water), and apparatus for use in treating contaminants in water (e.g., PFAS in water).

### BACKGROUND

Contaminated water is a major environmental and human health issue. Municipal wastewater plants, landfill leachate, industrial discharge, industrial retention ponds, municipal drinking water plants are all vectors for contaminants to enter our environment. Effects of some chemicals can be immediate, short term, medium term, and/or long term. Some chemicals like PFAS are bio-accumulative over time, such that the consistent ingestion of very small amounts can lead to significant health problems.

Current methods of degrading and mineralizing contaminants such as incineration, supercritical water oxidation, electrochemical oxidation, and hydrothermal alkaline treatment require the use of extreme conditions such as high temperature and pressure, high voltage, high power, and/or highly caustic environments.

A significant issue in waste management is the transportation, storage, and destruction of hazardous and non-hazardous wastes. Localized destruction eliminates transportation and storage thereby eliminating significant cost and environmental risk. However, destruction methods of many types of waste require extreme and unsafe conditions (high pressure, high temperature, high voltage, etc) and potentially generate hazardous secondary waste streams; thus, these methods are typically centralized at regional rather than local locations, requiring transportation waste collection, storage, and transportation.

There remains a need for more effective and efficient methods and apparatus for treating contaminants in fluids.

### BRIEF SUMMARY OF THE INVENTION

This section (i.e., “Brief Summary of the Invention”) presents a simplified summary of the present invention in order to provide a basic understanding of some aspects of the invention. Included in this section are some concepts of the invention as a prelude to more detailed descriptions of aspects of the present invention, and representative embodiments in accordance with aspects of the present invention.

The present invention provides effective and efficient methods for treating contaminants in fluids by combining processes that each individually would not be effective and efficient by themselves, and apparatus configured to carry out such methods.

In accordance with a first aspect of the present invention, there is provided a system for treating contaminant in a fluid, the system comprising:
a first stage, the first stage comprising a first contaminant concentration sub-stage and a first PCD sub-stage;
the first contaminant concentration sub-stage comprising a first-contaminant-concentration-sub-stage first inlet, a first-contaminant-concentration-sub-stage first outlet and a first-contaminant-concentration-sub-stage second outlet;
the first contaminant concentration sub-stage is configured to:
   receive through the first-contaminant-concentration-sub-stage first inlet a fluid supply, the fluid supply comprising an inlet concentration of a first contaminant;
   output from the first-contaminant-concentration-sub-stage first outlet a first-stage first portion comprising a first-stage first concentration of the first contaminant;
   output from the first-contaminant-concentration-sub-stage second outlet a first-stage second portion comprising a first-stage second concentration of the first contaminant, the first-stage first concentration of the first contaminant greater than the first-stage second concentration of the first contaminant;
the first PCD sub-stage comprises a first PCD vessel and a first PCD photocatalyst, the first PCD photocatalyst in the first PCD vessel;
the first PCD vessel comprises a first-PCD-vessel first inlet;
the first PCD sub-stage comprises a first-PCD-sub-stage first outlet;
the first-contaminant-concentration-sub-stage first outlet is fluid-flow connected to the first-PCD-vessel first inlet.

In accordance with a second aspect of the present invention, there is provided a method of treating a fluid containing contaminant, the method comprising:
supplying the fluid to a first contaminant concentration sub-stage of a first stage of a system, the first stage comprising the first contaminant concentration sub-stage and a first PCD (“PCD” refers to photocatalytic degradation) sub-stage, the first PCD sub-stage comprising a first PCD vessel and a first PCD photocatalyst, the first PCD photocatalyst is in the first PCD vessel;
outputting from a first-contaminant-concentration-sub-stage first outlet a first-stage first portion comprising a first-stage first concentration of the first contaminant;
outputting from a first-contaminant-concentration-sub-stage second outlet a first-stage second portion comprising a first-stage second concentration of the first contaminant, the first-stage first concentration of the first contaminant greater than the first-stage second concentration of the first contaminant;
supplying the first-stage first portion to the first PCD vessel; and
directing electromagnetic radiation at the first PCD vessel.

Photocatalytic degradation (PCD) can be carried out at atmospheric temperature and pressure and standard voltage and can be deployed locally. PCD can be more energy efficient as compared to other destruction and degradation methods. However, PCD does not operate efficiently in treating contaminants that are of the low concentrations found in many fluids, e. PFAS in water supplies, and especially at or near the target maximum concentrations for health and the environment.

Fractionation is an example of a technique that can be used to divide a feed volume of fluid containing one or more contaminants into two or more fractions of differing concentration, including at least one fraction (a contaminant fraction (CF)) that has a higher concentration of the contaminant(s) than the feed and at least one fraction (a base fraction (BF)) that has a lower concentration of the contaminant(s) than the feed.

Methods and apparatus in accordance with the present invention that employ both a technique for dividing a supply of fluid containing one or more contaminants into fractions of differing concentration, and PCD to treat one or more fractions that have a higher concentration of contaminant(s) than the fluid supply provide surprisingly efficient and effective treatment of contaminant in the supply of fluid.

PCD is an advanced oxidation process, which can be used to degrade molecules of high complexity and low biodegradability. Oxidation and hydrolysis of contaminant molecules occurs by an activation of a photocatalyst by absorption of photons of one or more electromagnetic regions (e.g., depending on the specific photocatalyst, visible, ultraviolet (UV), and infrared (IR). The activation of the photocatalytic material (photocatalyst material) with light (e.g., UV, visible and/or IR) leads to the migration of photo-responsive electrons from the valence to the conduction band, generating photo-induced electron and hole pairs. Photo-generated electron and hole pairs react with, e.g., oxygen, water and/or hydroxyl groups to produce reactive oxygen species, including but not limited to hydroxyl radicals and superoxide radical anions. These reactive oxygen species interact with contaminant molecules, resulting in complete or partial degradation of the contaminant molecules.

FIG. 1 is a representative example of a PCD graph of normalized concentration of a singular contaminant, versus time, that follows a typical exponential curve defined by Equation 1:

$$c / {c}_{0} = {Ae}^{- kt} \qquad Equation 1$$

where c is the concentration, c₀ is the initial concentration, k is a rate constant specific to the system and contaminant, and t is time. The graph and the equation demonstrate that as degradation progresses, it takes progressively longer to degrade the same amount of contaminant.

FIG. 2 is a representative example of a PCD graph, again for a singular contaminant, of normalized degradation rate (concentration change per unit time) versus concentration, that follows a typical logarithmic curve defined by Equation 2:

$$Deg Reg = a ln ( {C}_{1} ) + b \qquad Equation 2$$

where Deg Rate is the change in concentration per unit time, Cᵢ is the concentration of the molecule, and a and b are empirically derived constants. From the chart in FIG. 2 and Equation 2, a maximal degradation rate concentration can be defined such that below which the degradation rate decreases significantly with concentration, and above which the degradation rate is relatively stable and approaching a tangential maximum. A method of determining a maximal degradation rate concentration is to first normalize both the degradation rate and the concentration, second evaluate Equation 2 for the normalized values, third take the first derivative of the normalized Equation 2, fourth set the normalized y′ equal to 1 and solve for the normalized value of x. This provides the normalized concentration for the maximal degradation rate.

This degradation rate behavior can be explained by the dynamics of adsorption and degradation.

“Adsorption” refers to the adhesion of atoms, ions, or molecules from gas, liquid, or dissolved solid to a surface. An “adsorption coefficient” is a measure of the speed at which molecules (e.g., molecules of a surfactant) are adsorbed at the surface.

Adsorption behavior can generally be described by the Freundlich adsorption isotherm:

$$x / m = {KC}^{( j / n )} \qquad Equation 3$$

where x is the mass of adsorbate (molecule), m is the mass of adsorbent (photocatalyst), K is the adsorption coefficient for the adsorbent/adsorbate pair, C is the concentration of molecule in the liquid, and n is a correction factor.
Rearranging for adsorbate mass:

$$x = {mKC}^{( t / n )} \qquad Equation 4$$

The Freundlich isotherm, like the photocatalytic process, has a maximal adsorbate concentration, below which adsorbate mass decreases rapidly and above which is relatively stable and approaches a tangential maximum. As such, when the concentration in the liquid is below the maximal adsorbate concentration, the adsorbate amount will be low and thus the degradation rate will also be low. When the concentration in the liquid is at or above the maximal adsorbate concentration, the adsorbate is maximal and the degradation rate is not limited by adsorption.

There are further complications with PCD operation dynamics.

First, considering the case of a single contaminant, as the contaminant is degraded by photocatalysis, it can form new compounds (often fragments of the original) with relatively much lower adsorption coefficients. In such a case, the concentration of the new compounds in the liquid is zero and therefore the compounds desorb from the photocatalyst at an amount to achieve equilibrium in accordance with their isotherms. As the new compounds typically have lower adsorption coefficients, the amount remaining adsorbed is significantly less than that desorbed. As such, complete mineralization is limited.

Second, considering the case of multiple contaminants present in the liquid, when multiple contaminants are present, higher adsorption coefficient contaminants will be preferentially adsorbed, greatly limiting the degradation of the lower adsorption coefficient contaminants, including partially degraded compounds.

In accordance with the present invention, PCD is conducted in a batch mode, a continuous mode, or a combination of batch and continuous.

In batch mode of operation, the photocatalytic system is filled with the contaminated fluid (e.g., water) and the process activated. For a single contaminant, as the contaminant is adsorbed and degraded, the adsorbate is reduced. More contaminant is then adsorbed in accordance with the isotherm, with a reduced liquid concentration. For a single contaminant, the residence time, t_{K}, required for PCD is calculated by rearranging Equation 1 for time:

$${t}_{R} = - ln ( C / A ) / k \qquad Equation 5$$

For multiple contaminants with similar adsorption coefficients in batch mode, the contaminants will be adsorbed and degraded similarly and thus be treated as a single contaminant. A total concentration can be approximated by adding the concentrations of the contaminants:

$${C}_{r} = {C}_{1} + {C}_{2} + … + {C}_{n} \qquad Equation 6$$

Where C_{T} is the total concentration and Cₙ are the concentrations of n contaminants with similar adsorption coefficients.

Likewise, the rate constant k can be approximated using the average of the individual contaminants' rate constants:

$${k}_{avg} = ( {k}_{1} + … + {k}_{n} ) / n \qquad Equation 7$$

where k_{avg} is the average rate constant, kₙ are the concentrations of n contaminants with similar adsorption coefficients.

The residence time, t_{K} can be calculated using Equation 8:

$${t}_{R} = - ln ( {C}_{T} / A ) / {k}_{avg} \qquad Equation 8$$

For the case of multiple contaminants, the contaminants with the highest adsorption coefficient will be the predominant adsorbates. Lower adsorption coefficient contaminants are also adsorbed but at much lower amounts as the system balances the equilibrium between photocatalyst adsorbent capacity and the concentration of each contaminant in the liquid. As higher adsorption coefficient contaminant is adsorbed and degraded and its concentration in the liquid is reduced, its equilibrium adsorbate concentration reduces, freeing more of the photocatalyst for lower adsorption coefficient contaminants, including any new contaminants resulting from partial degradation. This relatively sequential cycle progresses per the isotherms for each contaminant.

The residence time, t_{R} can be calculated using Equation 9:

$${t}_{R} = {t}_{R 1} + {t}_{R 2} + … + {t}_{{R}_{n}} \qquad Equation 9$$

where t_{R1} is the residence time for a first set of adsorption coefficient contaminants, t_{R2} second set, and t_{Rn} an n^{th} set.

An advantage of batch mode in certain situations is that contaminants of differing adsorption coefficients can be degraded with the appropriate amount of time. However, batch mode can be disadvantageous due to extra controls and equipment needed to fill and unload the liquid, and to manage the photocatalyst.

In a continuous mode of operation, the photocatalytic system is filled with contaminated water while the process is active, and the treated water continuously flows out. Dwell time refers to the time (on average) that a fluid is in a particular process (dwell time=volume/flow rate). As a result, the contaminant concentration has a continuous replenishment and the concentrations of the system and of the PCD output will reach an equilibrium that is less than the incoming concentration but greater than zero. For a singular contaminant, to achieve a target PCD output, a residence time relative to the flow rate can be iteratively computed using Equation 1.

For multiple contaminants with similar adsorption coefficients and degradation dynamics, the sum of the individual concentrations can be used as the concentration and treated as a single contaminant for iterative computation using Equation 1.

For contaminants with similar adsorption coefficients but different degradation dynamics, the degradation occurs simultaneously but at different rates, and the degradation dynamics can be iteratively computed individually for each contaminant using Equation 1.

For the case of multiple adsorption rate coefficient contaminants with similar or different degradation dynamics, degradation occurs approximately sequentially from higher adsorption rate contaminants to lower. The degradation dynamics can be iteratively computed sequentially using Equation 1 for each contaminant.

An advantage of continuous mode relative to batch mode in certain situations is that there are fewer controls and less equipment to manage. However, because of continuous replenishment, the residence time required will be longer, increasing the amount or capacity of equipment required relative to batch mode.

In accordance with the present invention, dividing a feed volume of fluid containing one or more contaminants into two or more fractions of differing concentration, including at least one fraction (a contaminant fraction) that has a higher concentration of the contaminant(s) than the feed and at least one fraction (a base fraction) that has a lower concentration of the contaminant(s) than the feed (i.e., “increasing the concentration of contaminant in a fluid”) can be accomplished in any of a variety of ways, e.g., by fractionation, distillation, filtration, reverse osmosis, etc.

A particularly efficient and effective way of increasing the concentration of contaminant in a fluid in carrying out a method in accordance with the present invention, or in a system in accordance with the present invention, is by fractionation. Fractionation is a separation process in which a certain quantity of a mixture (of gasses, solids, liquids, enzymes, or isotopes, or a suspension) is divided during a phase transition, into a number of smaller quantities (fractions) in which the composition varies according to a gradient, i.e., including at least one fraction (a contaminant fraction) that has a higher concentration of the contaminant(s) than the feed and at least one fraction (a base fraction) that has a lower concentration of the contaminant(s) than the feed.

A configuration or method in which there are a series of fractionations in which a base fraction is a supply for each next fractionation is referred to herein as serial-separation. A configuration or method in which a contaminant fraction is a supply for each next fractionation (“sequential fractionation”) is referred to herein as contaminant concentration.

A particularly efficient and effective type of fractionation in carrying out a method in accordance with the present invention, or in a system in accordance with the present invention, is foam fractionation.

Foam fractionation is a type of fractionation process utilizing aeration of a liquid to fraction a proportion of the liquid into a foam fraction (FF). In the case where the initial liquid comprises contaminants with surface-active properties, the contaminants separate with the foam fraction. And if, in the foam, the contaminant proportion is greater than the liquid proportion from the initial liquid, the foam fraction will have a higher contaminant concentration than the initial liquid, and likewise the liquid fraction contaminant concentration lower. The net result is a concentration of contaminants into the foam fraction and a separation (removal) of contaminants from the liquid fraction.

Foam fractionation relies on the adsorption dynamics of molecules to liquid-air interfaces. Liquid-air interfaces exist at the bubbles, and the adsorption dynamics can generally be described by the Langmuir adsorption model:

$${θ}_{A} = KC / ( 1 + KC ) \qquad Equation 10$$

where θ_{A} is the fraction of available adsorption sites occupied, K is an adsorption coefficient for the adsorbent/adsorbate pair and represents the responsiveness, and C is the concentration of a molecule in the liquid. “Responsiveness” refers to the amount or rate at which a substance reacts to an environment; responsiveness includes but is not limited to a substance's activity, its adsorptivity, and/or its reactivity, Rearranging for C gives:

$$C = {θ}_{A} / K ( 1 - {θ}_{A} ) \qquad Equation 11$$

To minimize the concentration of contaminants remaining in the liquid, it is desired to maximize the adsorption coefficient and minimize the fraction of occupied adsorption sites. Foam fractionation, as a process, achieves this by continuously supplying unoccupied adsorption sites in the form of air bubbles that are readily removed.

Multiple factors affect the dynamics of the adsorption and removal of contaminants in foam fractionation systems, including but not limited to water drain and bubble collapse, responsiveness, simultaneous existence of contaminants of multiple responsiveness, residence time or dwell time, concentration of the contaminant, and operating modes.

Water drain from the foam occurs over time due to gravity and carries with it a portion of the contaminants. Bubble collapse also occurs over time as the surfaces of the bubbles seek the lowest equilibrium energy and combine into larger bubbles, reducing the interfacial surface area, thereby eliminating adsorption sites and leading to a proportion of contaminant being returned to the liquid. The longer the foam is resident above the liquid, the greater the amount of water that drains and the greater the amount of bubbles that collapse. Water height in a foam fractionation vessel is an adjustable parameter that affects the time foam is resident above the liquid. A higher water height results in less rise distance for the foam and therefore a lower foam residence time, while a lower water height results in a greater foam residence time.

Separation efficiency (SE) of a fractionation is a measure of the efficiency of isolating or extracting from a mixture, or becoming isolated from a mixture, and is defined as the ratio of one minus the concentration of contaminant in the base fraction, divided by the concentration of contaminant in the supply to the fractionation, i.e., separation efficiency=[(1−base fraction concentration)/supply concentration]×100%.

Operating foam fractionation in a mode of higher water height is preferable for maximal separation efficiency but results in a lower contaminant concentration in the foam fraction. An operating mode of lower water height is preferable for maximal concentration in the foam fraction but results in a lower separation efficiency.

The low responsiveness of some contaminants can inhibit the rate or the degree to which the contaminants can be adsorbed and therefore separated from liquids. A “response adjuster” is a substance that, when added to a mixture, adjusts the properties of a single, multiple, or all components to adjust the responsiveness of a single, multiple, or all contaminants. Certain response adjusters can be used to change characteristics such as conductivity, pH, polarity, etc. of the fractions and/or the contaminants, to increase the responsiveness of contaminants (e.g., by increasing their adsorption coefficient).

When multiple responsiveness contaminants exist, adsorption of each contaminant can be generally modeled by:

$${θ}_{1} = {K}_{1} {C}_{1} / ( 1 + {K}_{1} {C}_{1} + K … C … + K … C … + {K}_{n} {C}_{n} ) \qquad Equation 12$$

$${θ}_{1} = K … C … / ( 1 + {K}_{1} {C}_{1} + K … C … + K … C … + {K}_{n} {C}_{n} ) \qquad Equation 13$$

Contaminants with higher KC will be adsorbed preferentially. Only once the concentrations of contaminants of higher responsiveness are reduced will the lower responsiveness contaminants adsorb, Response adjusters may be tailored to specific contaminants, but often are indifferent, affecting multiple contaminants similarly. However, response adjusters may be detrimental to the environment and/or human health, add extra cost, change the taste and/or odor of liquids, or be difficult to manage as waste. Therefore, it can be best to minimize the use and amount of response adjusters through targeted and progressive deployment.

Dwell time in a foam fractionation vessel is an adjustable parameter that affects the amount of exposure the contaminants have to air liquid interfaces. Generally, longer dwell time leads to higher separation efficiencies and, when sufficient, will progressively separate those contaminants of lower responsiveness.

Fractionation can be operated in batch or continuous mode, and each affects contaminant separation and concentration differently.

Batch mode processes a fixed amount of a mixture, e.g., in the case of a foam fractionation, a foam fractionator vessel is filled with liquid, foam generation is activated, foam is separated, foam generation is ceased, and liquid is removed. Batch mode can be beneficial in certain situations for progressively separating contaminants of multiple responsiveness and for the addition of response adjusters at targeted times. However, batch mode can be disadvantageous in certain situations for fractionation processes because as the amount of the mixture decreases, the process dynamics and output changes. In foam fractionation, the progressive removal of liquid with the foam fraction results in a progressively lower liquid height and resulting decreased separation efficiency with time. In the case of multiple responsiveness contaminants, the reduced separation efficiency may occur at a time when lower responsiveness contaminants would be separated. Batch mode therefore may not be favorable in certain situations for the removal of multiple responsiveness contaminants.

Continuous mode maintains a consistent volume of a mixture, and therefore a more consistent separation efficiency. For example, in a representative example of continuous mode foam fractionation, upon filling the foam fractionator vessel, fluid can be supplied continuously at a rate that is high enough to replenish for water separated as foam and low enough to achieve no less than a target dwell time. Because of continuous contaminant replenishment, the residence times needed to achieve high separation efficiency can in certain situations be significantly increased. Also, replenishment of higher responsiveness contaminants limits separation of low responsiveness contaminants. In certain situations, continuous mode is not favorable for the removal of multiple responsiveness contaminants. The dwell time is set by adjusting the flow rates relative to the volume of the fractionation vessel (as noted above, dwell time=volume/flow rate).

The present invention may be more fully understood with reference to the accompanying drawings and the following detailed description of the invention.

### BRIEF DESCRIPTION OF THE DRAWING FIGURES

FIG. 1 is a chart of normalized concentration versus time of a PCD process.

FIG. 2 is a chart of normalized mass degradation rate versus normalized concentration of a PCD process.

FIG. 3 is a schematic drawing depicting a process for the degradation of contaminants utilizing sequential fractionation to concentrate contaminants for efficacious PCD.

FIG. 4 is a chart of output concentration versus time of a concentration with degradation process.

FIG. 5 is a schematic drawing depicting a process for the degradation of contaminants utilizing sequential fractionation to concentrate contaminants for efficacious PCD.

FIG. 6 is a table of mass, liquid, and concentration outputs by stage of a concentration with degradation process.

FIG. 7 is a schematic drawing depicting a process for the degradation of contaminants. utilizing sequential fractionation to concentrate contaminants for efficacious PCD.

FIG. 8 is a table of mass, liquid, and concentration outputs by stage of a concentration with degradation process.

FIG. 9 is a schematic drawing depicting a process for the degradation of contaminants utilizing sequential fractionation to concentrate contaminants for efficacious PCD.

FIG. 10 is chart of output concentration versus time of a concentration with degradation process.

FIG. 11 is a schematic drawing depicting a process for the degradation of contaminants utilizing sequential fractionation to concentrate contaminants for efficacious PCD.

FIG. 12 is a chart of output concentration versus time of a concentration with degradation process.

FIG. 13 is a schematic drawing depicting a process for the degradation of contaminants utilizing sequential fractionation to concentrate contaminants for efficacious PCD.

FIG. 14 is a table of mass, liquid, and concentration outputs by stage of a concentration with degradation process.

FIG. 15 is a schematic drawing depicting a process for the degradation of contaminants utilizing sequential fractionation to concentrate contaminants for efficacious PCD.

FIG. 16 is a chart of output concentration versus time of a concentration with degradation process.

FIG. 17 is a schematic drawing depicting a process for the degradation of contaminants utilizing sequential fractionation to concentrate contaminants for efficacious PCD.

FIG. 18 is a chart of output concentration versus time of a concentration with degradation process.

FIG. 19 is a schematic drawing depicting a process for the degradation of contaminants utilizing sequential fractionation to concentrate contaminants for efficacious PCD.

FIG. 20 is a table of mass, liquid, and concentration outputs by stage of a concentration with degradation process.

FIG. 21 is a schematic drawing depicting a process for the separation and segregation of contaminants utilizing serial fractionation.

FIG. 22 is a table of mass, liquid, and concentration outputs by stage of a concentration with degradation process.

FIG. 23 is a schematic drawing depicting a process for the separation and segregation of contaminants utilizing serial fractionation feeding sequential fractionations to concentrate contaminants for efficacious PCD.

FIG. 24 is a schematic drawing depicting a process for the separation and segregation of contaminants utilizing serial fractionation feeding sequential fractionations to concentrate contaminants for efficacious PCD.

FIG. 25 is a schematic drawing depicting a process for the separation and segregation of contaminants utilizing serial fractionation feeding sequential fractionations to concentrate contaminants for efficacious PCD.

FIG. 26 is a schematic drawing depicting a process for the separation and segregation of contaminants utilizing serial fractionation feeding sequential fractionations to concentrate contaminants for efficacious PCD.

FIG. 27 is a schematic drawing of a representative example of a foam fractionator 10 suitable for use as a fractionator in a system or method in accordance with the present invention.

FIG. 28 is a schematic drawing of a representative example of a PCD system 20 suitable for use as a PCD system in accordance with the present invention.

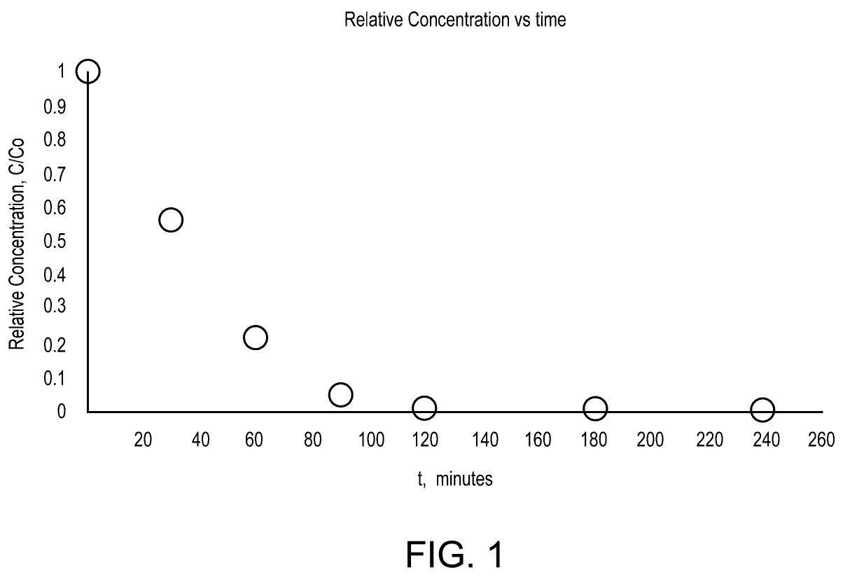

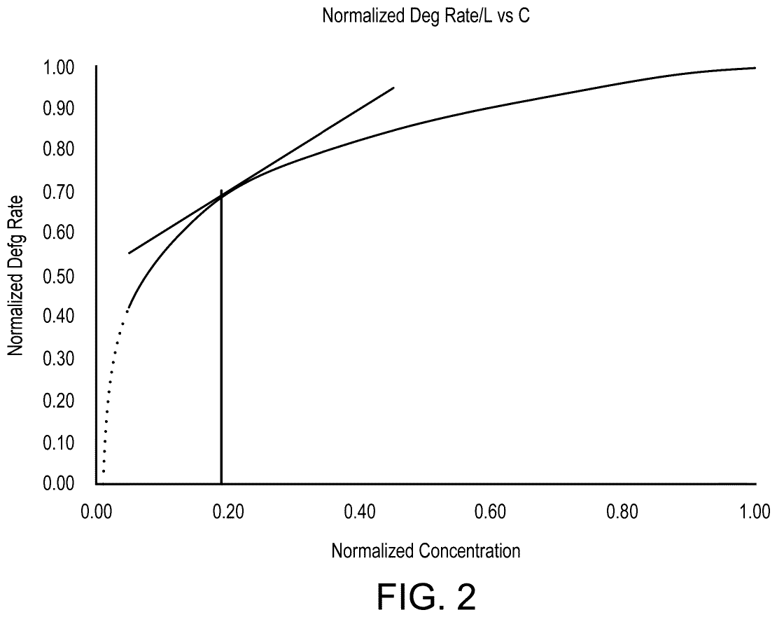

### DETAILED DESCRIPTION OF THE INVENTION

The expression “invention” is used herein to refer to any portion (or portions) of the inventive subject matter disclosed herein. As described herein, the present invention includes many aspects.

The expression “comprises” or “comprising.” is used herein in accordance with its well-known usage, and means that the item that “comprises” the recited elements (or that is “comprising” the recited elements) includes at least the recited elements, and can optionally include any additional elements. For example, an item that “comprises a first stage” can include only a single stage or it can include a plurality of stages, and may include no other items, or may further comprise any number of each of one or more items that is/are not recited. An item that comprises at least first and second recited elements can include only the two recited elements or can include three or more of the recited elements (e.g., a system that comprises first and second stages can optionally also comprise a third stage.

The expression “embodiment,” as used herein, means an embodiment in accordance with the present invention, i.e., an embodiment that is encompassed within the present inventive subject matter.

Where an expression is defined herein in terms of the meaning of the expression in the singular, the definition applies also to the plural (and vice-versa, i.e., for an expression defined herein in the plural, the definition applies also to the singular). Definitions of one form of an expression apply to the same expression in a different form of the word or words.

As used herein, the singular forms “a”, “an” and “the” are intended to include the plural forms as well, unless the context clearly indicates otherwise.

The expressions “in some embodiments” and “in some of such embodiments” as used herein, refer to features that can be included in some embodiments and not others, i.e., the feature(s) is/are optional. Where the expression “in some embodiments” or the expression “in some of such embodiments” is used, the embodiment can include the feature discussed, and can also include or not include any of other features described herein, including features that are similarly described as being provided “in some embodiments” or “in some of such embodiments.”

As used herein the term “and/or” includes any and all combinations of one or more of the associated listed items.

Although numerical terms (e.g., “first”, “second”, etc. may be used herein to refer to various stages (e.g., “a first stage”), contaminant concentration sub-stages, PCD sub-stages, contaminant-concentration-sub-stage inlets, a contaminant-concentration-sub-stage outlets, contaminants, concentrations, etc., such stages, contaminant concentration sub-stages, PCD sub-stages, contaminant-concentration-sub-stage inlets, a contaminant-concentration-sub-stage outlets, contaminants, concentrations, etc. are not limited by these terms. These terms are only used to distinguish, if applicable, one of a type of items from another of the same or similar type of items. Thus, a first stage or other item discussed herein could instead be termed a second stage or other item (and vice-versa). Likewise, in a system with only one stage, the one stage can be referred to as the first stage.

Any statement herein that an item is “configured to” perform some action means that the item—or some part (or parts) of the item—is capable of performing such action.

A statement herein that a first item is “fluid-flow connected” to a second item, e.g. “a first fractionation column contamination fraction outlet is fluid-flow connected to a second fractionation column input” means that fluid can flow from the first item (e.g., the first fractionation column contamination fraction outlet) to the second item (e.g., the second fractionation column input). For example, one or more pipes connect—i.e., provide for fluid flow between—the first item and the second item. First and second items can be fluid-flow connected despite the presence of one or more fluid-handling components between the first and second items, e.g., even where fluid must flow through one or more tanks, filters, pumps, backflow preventers, valves, fittings, meters, couplings, meter stops, pressure regulators, manifolds, or other fluid-handling components or systems, to get from the first item to the second item.

The term “fluid,” as used herein, means liquid and/or gas, i.e., a volume of liquid, a volume of gas, or a volume that contains liquid and gas. A fluid can include some solids, e.g., suspended or entrained.

The term “supplying” (e.g., in the expression “supplying the fluid to a first contaminant concentration sub-stage of a first stage”), as used herein, means to supply a fluid in one or more batches and/or as a continuous stream for a period of time. In addition, a statement that fluid is supplied from a particular outlet to a particular inlet means that some or all of the fluid exiting that outlet is supplied to that inlet (i.e., the statement encompasses arrangements in which some of the fluid is diverted elsewhere). In addition, a statement that fluid is supplied to a component can mean that the fluid is the only thing being supplied to the component, or is supplied as a separate stream to the component (i.e., not mixed or combined with anything else before entering the component), or is mixed or combined with one or more other fluids (e.g., one or more other fluid-flows) before or as being supplied to the component.

The expression “directing electromagnetic radiation at” an item (e.g., in the expression “directing electromagnetic radiation at the first PCD vessel”), as used herein, means causing electromagnetic radiation to hit the item such that the item is hit by more electromagnetic radiation than if electromagnetic radiation were not directed at the item (i.e., the item receives more electromagnetic radiation than it would receive from any ambient light).

Unless otherwise defined, all terms (including technical and scientific terms) used herein have the same meaning as commonly understood by one of ordinary skill in the art to which this invention belongs. Terms and expressions, such as those defined in commonly used dictionaries, should each be interpreted as having a meaning that is consistent with their meaning in the context of the relevant art and the present disclosure, and not in an idealized or overly formal sense (unless expressly so defined herein).

As noted above, in a first aspect of the present invention, there is provided a system for treating contaminant in a fluid, the system comprising:
a first stage, the first stage comprising a first contaminant concentration sub-stage and a first PCD sub-stage;
the first contaminant concentration sub-stage comprising a first-contaminant-concentration-sub-stage first inlet, a first-contaminant-concentration-sub-stage first outlet and a first-contaminant-concentration-sub-stage second outlet;
the first contaminant concentration sub-stage is configured to:
   receive through the first-contaminant-concentration-sub-stage first inlet a fluid supply, the fluid supply comprising an inlet concentration of a first contaminant;
   output from the first-contaminant-concentration-sub-stage first outlet a first-stage first portion comprising a first-stage first concentration of the first contaminant;
   output from the first-contaminant-concentration-sub-stage second outlet a first-stage second portion comprising a first-stage second concentration of
   the first contaminant, the first-stage first concentration of the first contaminant greater than the first-stage second concentration of the first contaminant;
the first PCD sub-stage comprises a first PCD vessel and a first PCD photocatalyst, the first PCD photocatalyst in the first PCD vessel;
the first PCD vessel comprises a first-PCD-vessel first inlet;
the first PCD sub-stage comprises a first-PCD-sub-stage first outlet;
the first-contaminant-concentration-sub-stage first outlet is fluid-flow connected to the first-PCD-vessel first inlet.

In some embodiments in accordance with the first aspect of the present invention, and in some embodiments in accordance with the second aspect of the present invention, the first contaminant concentration sub-stage comprises at least a first fractionation column.

In some embodiments in accordance with the first aspect of the present invention, and in some embodiments in accordance with the second aspect of the present invention:
the first contaminant concentration sub-stage comprises a plurality of fractionation columns, the plurality of fractionation columns comprising a first series of at least two fractionation columns starting with a first fractionation column and ending with a last fractionation column,
each fractionation column in the first series of fractionation columns comprises a fractionation-column inlet, a contaminant-fraction outlet and a base-fraction outlet.
for each fractionation column in the first series of fractionation columns except for the last fractionation column, the contaminant-fraction outlet is fluid-flow connected to an inlet of a fractionation column that is next in the first series of fractionation columns,
a contaminant-fraction outlet of the last fractionation column is fluid-flow connected to an inlet of the first PCD vessel.

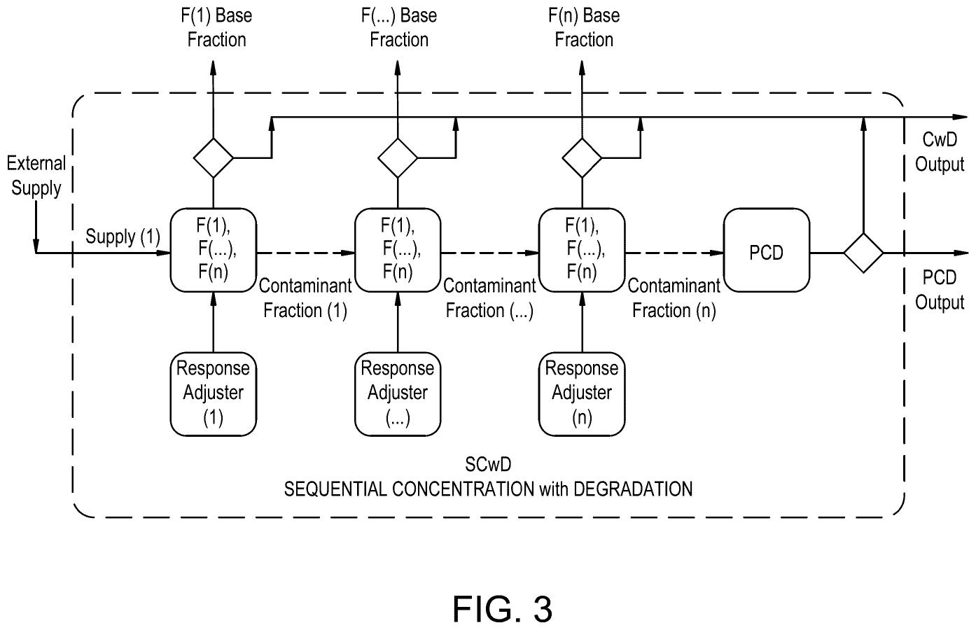

FIG. 3 depicts an embodiment of such a system and method.

In some of such embodiments:
the system further comprises at least a first serial-separation stage, the first serial-separation stage comprising a first series of separation-stage fractionation columns starting with a first separation-stage fractionation column and ending with a last separation-stage fractionation column,
each separation-stage fractionation column in the first series of separation-stage fractionation columns comprises a separation-stage-fractionation-column inlet, separation-stage-contaminant-fraction outlet and a separation-stage-base-fraction outlet,
for each separation-stage fractionation column in the first series of separation-stage fractionation columns except for the last separation-stage fractionation column, the base-fraction outlet from that separation-stage fractionation column is fluid-flow connected to a next separation-stage fractionation column in the first series of separation-stage fractionation columns,
a separation-stage-contaminant-fraction outlet of at least one of the separation-stage fractionation columns is fluid-flow connected to the first-contaminant-concentration-sub-stage first inlet.

FIG. 3 depicts a sequential concentration with degradation (SCwD) system and method. An SCwD system and method as depicted in FIG. 3 can be particularly effective as a system and method that degrades contaminants of low concentrations and outputs a concentration lower than the supplied concentration while operating PCD at a maximal efficiency.

As shown in FIG. 3, SCwD is a method utilizing sequential fractionations with response adjuster 1 through response adjuster n, outputs of F(1) through F(n) base fraction outputs, a PCD output, and a CwD output where a single, multiple, or all F(1) through F(n) base fraction outputs and a PCD output can have none, some, or all directed to a CwD output.

Sequential fractionations increase the contaminant concentration to greater than or equal to a maximal degradation rate concentration.

The number of sequential fractionations, S is calculated:

$$S = Log {F}_{c} ( {C}_{max} / {C}_{supply} ) \qquad Equation 14$$

where F_{c} is a concentration factor, Cₘₐₓ is a maximal degradation rate concentration, and C_{Supply} is a supply concentration. The concentration factor for a fractionation column is equal to the concentration of contaminant in the foam fraction from that column divided by concentration of contaminant in the fluid supplied to that column.

The residence time of PCD is set to achieve a target PCD output concentration.

The total output concentration=sum of the contaminant masses of base fractions (1, . . . , n) and the PCD output divided by a total liquid output volume.

Response adjusters may be added in each fractionation to enhance the separation efficiency for all or specific contaminants.

A best mode for sequential concentration with degradation (SCwD) for a supply of water with a starting concentration of greater than 50 ng/L and less than 101 ng/L of perfluorooctanoic acid is as follows:
A PCD system is operated with a residence time of at least 17 minutes in continuous mode. A PCD system comprises 2.5 g/L of hexagonal boron nitride photocatalyst and UV-C lamps with optical output more than 150 W/L, with constants a=105×10³ and b=−1×10⁶ for Equation 2 and a maximal degradation rate concentration of Cₘₐₓ=10×10⁶ ng/L.
Six foam fractionation processes are arranged sequentially. A first foam fractionation process yields a separation efficiency greater than 99%. Each foam fractionation process 2 through 6 yields a separation efficiency greater than 90% and a concentration factor of greater than or equal to 9.

In general, the values for a and b in equation 2 can be affected by selection of the material (or materials) used as the PCD photocatalyst, the morphology of material(s) used as the PCD photocatalyst (e.g., greater surface area per volume provides an increase in a and/or a decrease in b), and/or the adsorption of photons per volume of photocatalyst material. In some cases, ball-milling a photocatalyst can provide improved activity, e.g., an increase in a and/or a decrease in b.

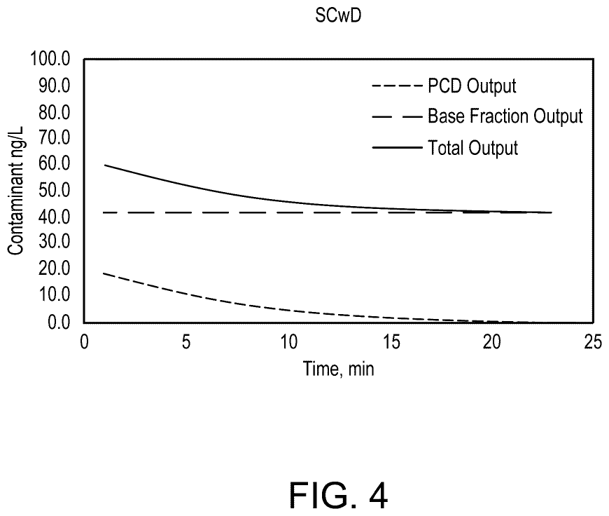

FIG. 4 contains a chart showing a concentration of a contaminant output from process initiation to stabilization.

In some embodiments in accordance with the first aspect of the present invention, and in some embodiments in accordance with the second aspect of the present invention;
the system further comprises a second stage, the second stage comprising a second contaminant concentration sub-stage and a second PCD sub-stage, the second contaminant concentration sub-stage comprising a second-stage first inlet,
the second contaminant concentration sub-stage comprises a second-contaminant-concentration-sub-stage first outlet and a second-contaminant-concentration-sub-stage second outlet,
the second contaminant concentration sub-stage is configured to:
   receive fluid from the first-PCD-sub-stage first outlet;
   output from the second-contaminant-concentration-sub-stage first outlet a second-stage first portion comprising a second-stage first concentration of the first contaminant;
   output from the second-contaminant-concentration-sub-stage second outlet a second-stage second portion comprising a second-stage second concentration of the first contaminant, the second-stage first concentration of the first contaminant greater than the second-stage second concentration of the first contaminant;
the second PCD sub-stage comprises a second PCD vessel and a photocatalyst in the second PCD vessel;
the second PCD vessel comprises a second-PCD-vessel first inlet,
the second-contaminant-concentration-sub-stage first outlet is fluid-flow connected to the second-PCD-vessel first inlet, and
the first-PCD-sub-stage first outlet is fluid flow-connected to the second-stage first inlet.

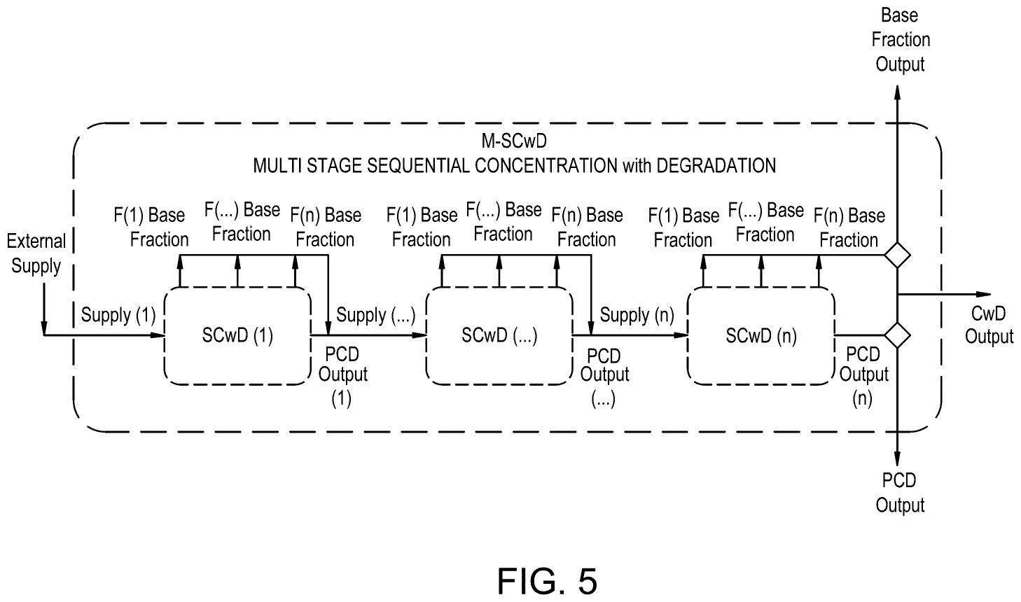

FIG. 5 depicts an embodiment of such a system and method.

In some of such embodiments:
each contaminant concentration sub-stage comprises a series of at least two fractionation columns starting with a first fractionation column and ending with a last fractionation column,
for each series of fractionation columns, each fractionation column in that series of fractionation columns comprises a contaminant-fraction outlet and a base-fraction outlet,
for each series of fractionation columns, for each fractionation column in that series of fractionation columns except for the last fractionation column, the contaminant-fraction outlet is fluid-flow connected to an inlet of a fractionation column that is next in that series of fractionation columns,
for each series of fractionation columns, a contaminant-fraction outlet of the last fractionation column in that series is fluid-flow connected to an inlet of the PCD vessel in the same stage.

FIG. 5 depicts a multistage sequential concentration with degradation (M-SCwD) system and method.

With each fractionation in SCwD, more contaminant is discharged in the base fractions. A lower separation efficiency of any, multiple, or all fractionations may limit the ability of the process to achieve a target concentration. Also, a plurality of lower responsiveness contaminants may be discharged in the base fractions.

An M-SCwD system and method as depicted in FIG. 5 can be particularly effective as a system and method that degrades contaminants and achieves a net output less than or equal to target concentrations of contaminants of multiple responsiveness while operating PCD at a maximal efficiency.

As shown in FIG. 5, M-SCwD is a method utilizing sequential SCwD processes with outputs of F(1) through F(n) base fraction outputs and a PCD output with a final SCwD having F(1) through F(n) base fraction outputs directed to a base fraction output and/or a CwD output and a PCD output(n) directed to a PCD output and/or a CwD output.

Base fractions and a PCD output discharged from a SCwD process are contained and fed into a next SCwD stage. SCwD stages progressively degrade similar responsiveness contaminants and multiple responsiveness contaminants from higher to lower responsiveness. A number of stages S required can be calculated:

$$T = {m}_{s} ( 1 - {SE}_{F 1} ) + {\int }_{2}^{S} {CF}_{( i - 1 )} ( 1 - {SE}_{Fi} )$$

where T is the target concentration, mₛ is the mass of the contaminant in the supply, SE_{Fi} is the separation efficiency of fractionation i, and CF₍ᵢ₋₁₎ is the contaminant fraction of fractionation (i−1).

A best mode for mulitstage sequential concentration with degradation (M-SCwD) for a supply of water with a starting concentration of greater than 50 ng/L and less than 101 ng/L of perfluorooctanoic acid and a starting concentration of greater than 50 ng/L and less than 101 ng/L of perfluorobutane sulfonate is as follows:
SCwD processes consist of six foam fractionation processes arranged sequentially and a PCD process. A first foam fractionation process yields a separation efficiency greater than 99%. Each foam fractionation processes 2 through 6 yield a separation efficiency greater than 90% and a concentration factor of greater than or equal to 9. A PCD system is operated in continuous mode comprising 2.5 g/L of hexagonal boron nitride photocatalyst and UV-C lamps with optical output more than 150 W/L, with constants a=105×10³ and b=−1×10⁶ for Equation 2 and a maximal degradation rate concentration of Cₘₐₓ=10×10⁶ ng/L.
A number of stages is at least 8.
Residence times for a PCD system in each stage are at least 15, 7, 2, and 1 minutes for stages 1 and 5, 2 and 6, 3 and 7, and 4 and 8, respectively.

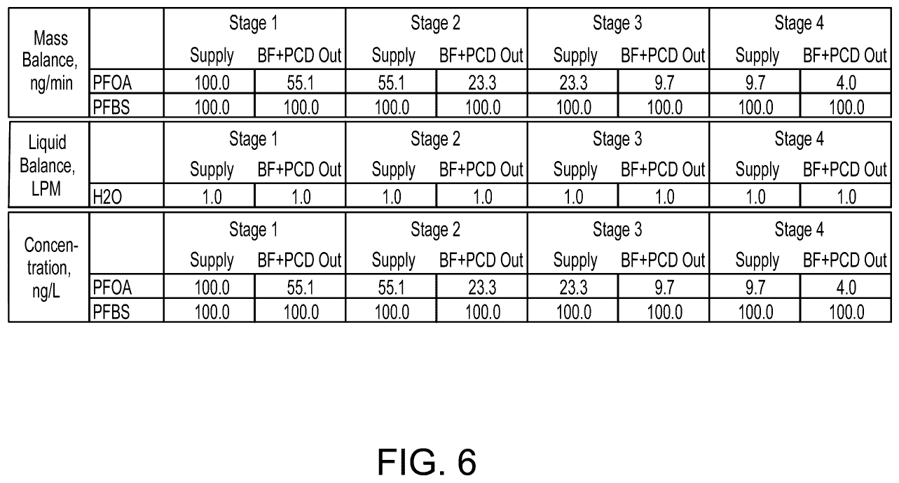

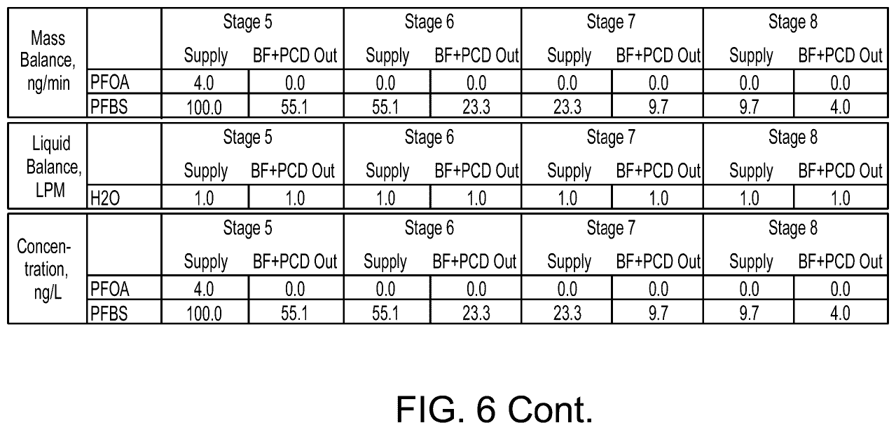

FIG. 6 contains a table showing concentrations of contaminants output from each process stage.

In some embodiments in accordance with the first aspect of the present invention, and in some embodiments in accordance with the second aspect of the present invention:
the system comprises a series of stages comprising the first stage and at least one additional stage, the series of stages starting with the first stage and ending with a last stage,
each of the at least one additional stage comprises a respective contaminant concentration sub-stage and a PCD sub-stag
each contaminant concentration sub-stage comprises a respective first inlet, a respective first outlet and a respective second outlet,
each contaminant concentration sub-stage is configured to:
   receive fluid through its first inlet;
   output from its first outlet a respective first portion comprising a first concentration of the first contaminant;
   output from its second outlet a respective second portion comprising a second concentration of the first contaminant, the respective first concentration of the first contaminant greater than the respective second concentration of the first contaminant;
each PCD sub-stage comprises a respective PCD vessel and a respective photocatalyst in the respective PCD vessel,
each PCD vessel comprises a respective PCD-vessel first inlet, and
for at least one stage in the series of stages, a PCD outlet for that stage is fluid-flow connected to a contaminant-concentration-sub-stage inlet for a stage that is next in the series of stages.

In some of such embodiments:
for each stage in the series of stages except for the last stage, a PCD outlet for that stage is fluid-flow connected to a contaminant-concentration-sub-stage inlet for a stage that is next in the series of stages.

In some of such embodiments:
each contaminant concentration sub-stage comprises a series of at least two fractionation columns starting with a first fractionation column and ending with a last fractionation column,
for each series of fractionation columns, each fractionation column in that series of fractionation columns comprises a contaminant-fraction outlet and a base-fraction outlet,
for each series of fractionation columns, for each fractionation column in that series of fractionation columns except for the last fractionation column, the contaminant-fraction outlet is fluid-flow connected to an inlet of a fractionation column that is next in that series of fractionation columns,
for each series of fractionation columns, a contaminant-fraction outlet of the last fractionation column in that series is fluid-flow connected to an inlet of the PCD vessel in the same stage,
In some embodiments in accordance with the first aspect of the present invention, and in some embodiments in accordance with the second aspect of the present invention;
the system further comprises a second stage, the second stage comprising a second contaminant concentration sub-stage and a second PCD sub-stage,
the second contaminant concentration sub-stage comprises a second-stage first inlet,
the second contaminant concentration sub-stage comprises a second-contaminant-concentration-sub-stage first outlet and a second-contaminant-concentration-sub-stage second outlet,
the second contaminant concentration sub-stage is configured to:
   receive fluid from the first-contaminant-concentration-sub-stage second outlet;
   output from the second-contaminant-concentration-sub-stage first outlet a second-stage first portion comprising a second-stage first concentration of the first contaminant;
   output from the second-contaminant-concentration-sub-stage second outlet a second-stage second portion comprising a second-stage second concentration of the first contaminant, the second-stage first concentration of the first contaminant greater than the second-stage second concentration of the first contaminant;
the second PCD sub-stage comprises a second PCD vessel and a photocatalyst in the second PCD vessel,
the second PCD vessel comprises a second-PCD-vessel first inlet,
the second-contaminant-concentration-sub-stage first outlet is fluid-flow connected to the second-PCD-vessel first inlet, and
the first-contaminant-concentration-sub-stage second outlet is fluid-flow connected to the second contaminant concentration sub-stage.

In some of such embodiments:
each contaminant concentration sub-stage comprises a series of at least two fractionation columns starting with a first fractionation column and ending with a last fractionation column,
for each series of fractionation columns, each fractionation column in that series of fractionation columns comprises a contaminant-fraction outlet and a base-fraction outlet,
for each series of fractionation columns, for each fractionation column in that series of fractionation columns except for the last fractionation column, the contaminant-fraction outlet is fluid-flow connected to an inlet of a fractionation column that is next in that series of fractionation columns,
for each series of fractionation columns, a contaminant-fraction outlet of the last fractionation column in that series is fluid-flow connected to an inlet of the PCD vessel in the same stage.

In some of such embodiments:
the first-PCD-sub-stage first outlet is fluid flow-connected to the first-contaminant-concentration-sub-stage first inlet.

In some embodiments in accordance with the first aspect of the present invention, and in some embodiments in accordance with the second aspect of the present invention:
the system comprises a series of stages comprising the first stage and at least one additional stage, the series of stages starting with the first stage and ending with a last stage,
each of the at least one additional stage comprises a respective contaminant concentration sub-stage and a PCD sub-stage,
each contaminant concentration sub-stage comprises a respective first inlet, a respective first outlet and a respective second outlet,
each contaminant concentration sub-stage is configured to:
   receive fluid through its first inlet;
   output from its first outlet a respective first portion comprising a first concentration of the first contaminant;
   output from its second outlet a respective second portion comprising a second concentration of the first contaminant, the respective first concentration of the first contaminant greater than the respective second concentration of the first contaminant;
each PCD sub-stage comprises a respective PCD vessel and a respective photocatalyst in the respective PCD vessel,
each PCD vessel comprises a respective PCD-vessel first inlet, and
for at least one stage in the series of stages, a contaminant-concentration-sub-stage second outlet is fluid-flow connected to a contaminant-concentration-sub-stage inlet for a stage that is next in the series of stages.

In some of such embodiments, for each stage in the series of stages except for the last stage, a contaminant-concentration-sub-stage second outlet is fluid-flow connected to a contaminant-concentration-sub-stage inlet for a stage that is next in the series of stages.

In some of such embodiments:
each contaminant concentration sub-stage comprises a series of at least two fractionation columns starting with a first fractionation column and ending with a fast fractionation column,
for each series of fractionation columns, each fractionation column in that series of fractionation columns comprises a contaminant-fraction outlet and a base-fraction outlet,
for each series of fractionation columns, for each fractionation column in that series of fractionation columns except for the last fractionation column, the contaminant-fraction outlet is fluid-flow connected to an inlet of a fractionation column that is next in that series of fractionation columns,
for each series of fractionation columns, a contaminant-fraction outlet of the last fractionation column in that series is fluid-flow connected to an inlet of the PCD vessel in the same stage.

In some of such embodiments:
for at least one of the stages in the series of stages, a PCD outlet is fluid flow-connected to a contaminant-concentration-sub-stage inlet of that stage.

In some embodiments in accordance with the first aspect of the present invention, and in some embodiments in accordance with the second aspect of the present invention:
the system further comprises a second stage, the second stage comprising a second contaminant concentration sub-stage and a second PCD sub-stage,
the second contaminant concentration sub-stage comprising a second-stage first inlet,
the second contaminant concentration sub-stage comprises a second-contaminant-concentration-sub-stage first outlet and a second-contaminant-concentration-sub-stage second outlet,
the second contaminant concentration sub-stage is configured to:
   receive fluid from the first-PCD-sub-stage first outlet;
   receive fluid from the first-contaminant-concentration-sub-stage second outlet;
   output from the second-contaminant-concentration-sub-stage first outlet a second-stage first portion comprising a second-stage first concentration of the first contaminant;
   output from the second-contaminant-concentration ub-stage second outlet a second-stage second portion comprising a second-stage second concentration of the first contaminant, the second-stage first concentration of the first contaminant greater than the second-stage second concentration of the first contaminant;
the second PCD sub-stage comprises a second PCD vessel and a photocatalyst in the second PCD vessel,
the second PCD vessel comprises a second-PCD-vessel first inlet,
the second-contaminant-concentration-sub-stage first outlet is fluid-flow connected to the second-PCD-vessel first inlet,
the first-PCD-sub-stage first outlet is fluid flow-connected to the second contaminant concentration sub-stage, and
the first-contaminant-concentration-sub-stage second outlet is fluid-flow connected to the second contaminant concentration sub-stage.

In some of such embodiments:
each contaminant concentration sub-stage comprises a series of at least two fractionation columns starting with a first fractionation column and ending with a last fractionation column,
for each series of fractionation columns, each fractionation column in that series of fractionation columns comprises a contaminant-fraction outlet and a base-fraction outlet,
for each series of fractionation columns, for each fractionation column in that series of fractionation columns except for the last fractionation column, the contaminant-fraction outlet is fluid-flow connected to an inlet of a fractionation column that is next in that series of fractionation columns,
for each series of fractionation columns, a contaminant-fraction outlet of the last fractionation column in that series is fluid-flow connected to an inlet of the PCD vessel in the same stage.

In some embodiments in accordance with the first aspect of the present invention, and in some embodiments in accordance with the second aspect of the present invention:
the system comprises a series of stages comprising the first stage and at least one additional stage, the series of stages starting with the first stage and ending with a last stage,
each of the at least one additional stage comprises a respective contaminant concentration sub-stage and a PCD sub-stage,
each contaminant concentration sub-stage comprises a respective first inlet, a respective first outlet and a respective second outlet,
each contaminant concentration sub-stage is configured to:
   receive fluid through its first inlet;
   output from its first outlet a respective first portion comprising a first concentration of the first contaminant;
   output from its second outlet a respective second portion comprising a second concentration of the first contaminant, the respective first concentration of the first contaminant greater than the respective second concentration of the first contaminant;
each PCD sub-stage comprises a respective PCD vessel and a respective photocatalyst in the respective PCD vessel,
each PCD vessel comprises a respective PCD-vessel first inlet,
for at least one stage in the series of stages, a PCD outlet for that stage is fluid-flow connected to a contaminant-concentration-sub-stage inlet for a stage that is next in the series of stages, and
for at least one stage in the series of stages, a contaminant-concentration-sub-stage second outlet is fluid-flow connected to a contaminant-concentration-sub-stage inlet for a stage that is next in the series of stages.

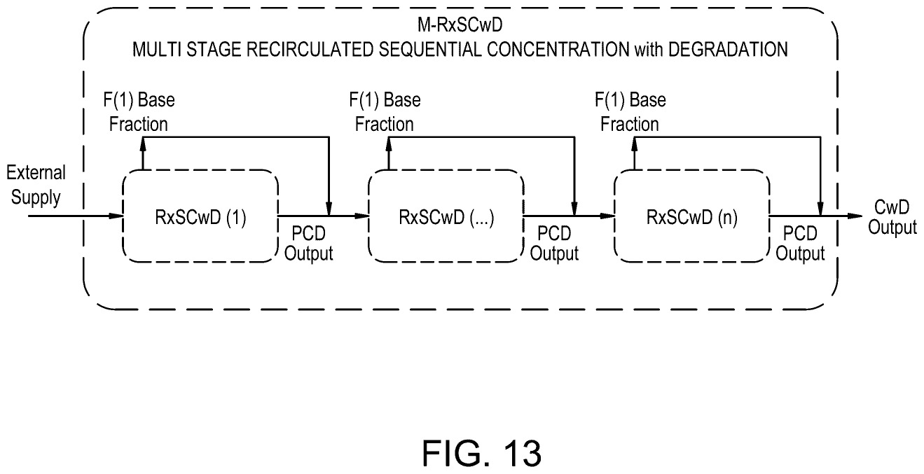

FIG. 13 depicts an embodiment of such a system and method.

In some of such embodiments:
for each stage in the series of stages except for the last stage, a PCD outlet for that stage is fluid-flow connected to a contaminant-concentration-sub-stage inlet for a stage that is next in the series of stages, and for each stage in the series of stages except for the last stage, a contaminant-concentration-sub-stage second outlet is fluid flow connected to a contaminant-concentration-sub-stage inlet for a stage that is next in the series of stages.

In some of such embodiments:
each contaminant concentration sub-stage comprises a series of at least two fractionation columns starting with a first fractionation column and ending with a last fractionation column,
for each series of fractionation columns, each fractionation column in that series of fractionation columns comprises a contaminant-fraction outlet and a base-fraction outlet,
for each series of fractionation columns, for each fractionation column in that series of fractionation columns except for the last fractionation column, the contaminant-fraction outlet is fluid-flow connected to an inlet of a fractionation column that is next in that series of fractionation columns,
for each series of fractionation columns, a contaminant-fraction outlet of the last fractionation column in that series is fluid-flow connected to an inlet of the PCD vessel in the same stage.

FIG. 13 depicts a multistage recirculated sequential concentration with degradation (M-RXSCwD) system and method.

In some situations, RPSCwD and RFSCwD processes may discharge lower responsiveness contaminants in a first fractionation base fraction and a PCD output.

An M-RXSCwD system and method as depicted in FIG. 13 can be particularly effective as a system and method that degrades contaminants and achieves a net output less than or equal to target concentrations for contaminants of multiple responsiveness while operating PCD at a maximal efficiency.

As shown in FIG. 13, M-RXSCwD is a method utilizing sequential RXSCwD processes with outputs of an F(1) base fraction outputs and a PCD output with a final RXSCwD having an F(1) base fraction output and a PCD output directed to a CwD output.

Base fractions and a PCD output, discharged from RXSCwD processes, are contained and input into a supply of a sequential RXSCwD process. RXSCwD processes progressively degrade contaminants according to responsiveness. A number of sequential RXSCwD processes produce a net concentration comprising a last fractionation output and a PCD output less than or equal to target concentrations of multiple responsive contaminants.

A best mode for M-RXSCwD for a supply of water with a starting concentration of greater than 50 ng/L and less than 101 ng/L of perfluorooctanoic acid and a starting concentration of greater than 50 ng/L and less than 101 ng/L of perfluorobutane sulfonate is as follows:
Sequential RFSCwD processes consist of six foam fractionations arranged sequentially and a PCD process. A first foam fractionation process yields a separation efficiency greater than 99%, Each foam fractionation process 2 through 6 yields a separation efficiency greater than 90% and a concentration factor of greater than or equal to 9. A PCD system operated in continuous mode comprising 2.5 g/L of hexagonal boron nitride photocatalyst and UV-C lamps with optical output more than 150 W/L, with constants a=105×10³ and b=−1×10⁶ for Equation 2 and a maximal degradation rate concentration of Cₘₐₓ=10×10⁶ ng/L.
A number of sequential RFSCwD processes is at least 2.
Residence times for a PCD system in each stage are at least 19.2 minutes, for stages 1 and 2

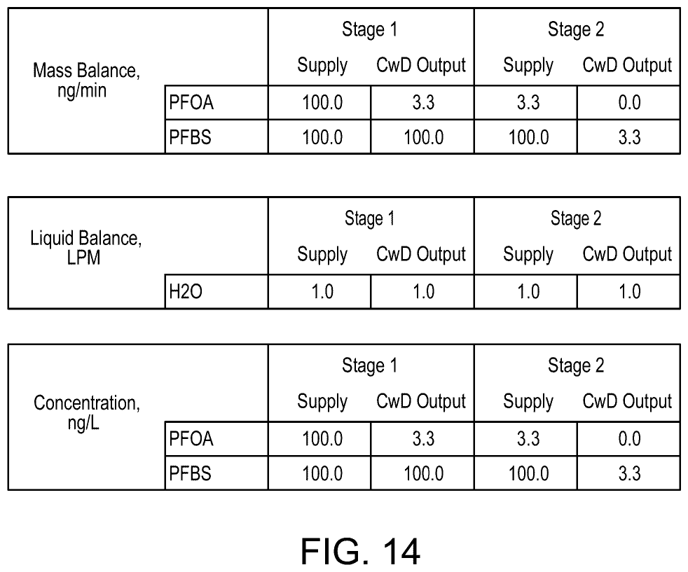

FIG. 14 contains a table showing concentrations of contaminants output from each process stage.

In some embodiments in accordance with the first aspect of the present invention, and in some embodiments in accordance with the second aspect of the present invention:
the first-PCD-sub-stage first outlet is fluid flow-connected to the first-contaminant-concentration-sub-stage first inlet.

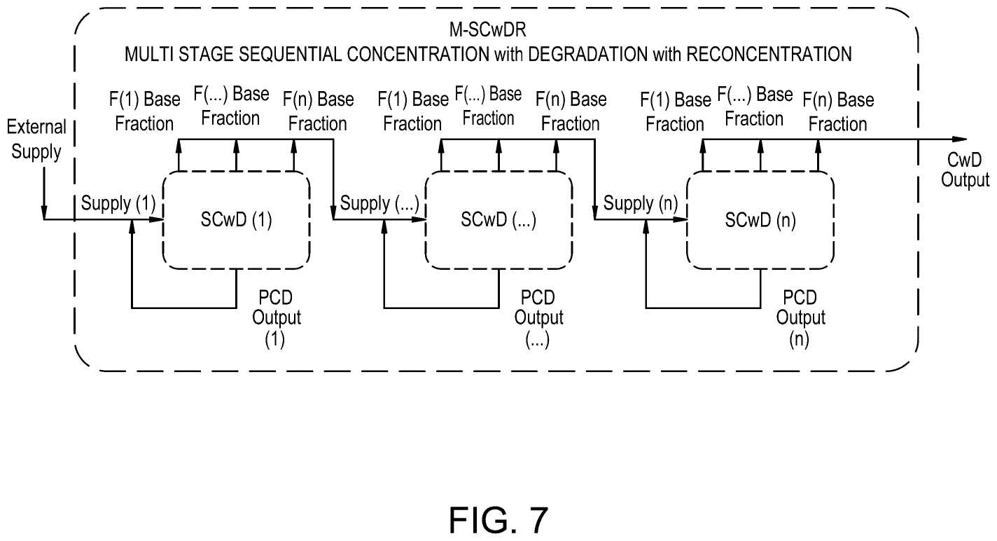

FIG. 7 depicts an embodiment of such a system and method.

FIG. 7 depicts a multistage sequential concentration with degradation with re-concentration (M-SCwDR) system and method.

With each fractionation in SCwD, more contaminant is discharged in the base fractions. A lower separation efficiency of any, multiple, or all fractionations may limit the ability of the process to achieve a target concentration. Also, a plurality of lower responsiveness contaminants may be discharged in the base fractions.

An M-SCwDR system and method as depicted in FIG. 7 can be particularly effective as a system and method that degrades contaminants and achieves a net output equal to target concentrations of contaminants of multiple responsiveness while operating PCD at a maximal efficiency.

As shown in FIG. 7, M-SCwDR is a method utilizing sequential SCwD processes with outputs of F(1) through F(n) base fraction outputs and a PCD output returned to a SCwD with a final SCwD having F(1) through F(n) base fraction outputs directed to a CwD output and a PCD output returned to a SCwD.

Base fractions discharged from a SCwD process are contained and fed into a next SCwD stage, and a PCD output is returned to the supply of an existing stage. SCwD stages progressively degrade similar responsiveness contaminants and multiple responsiveness contaminants from higher to lower responsiveness. A number of stages S required can be calculated:

$$T = {m}_{s} ( 1 - {SE}_{F 1} ) + {\int }_{2}^{S} {CF}_{( i - 1 )} ( 1 - {SE}_{Fi} )$$

where T is the target concentration, mₛ is the mass of the contaminant in the supply, SE_{Fi} is the separation efficiency of fractionation i, and CF₍ᵢ₋₁₎ is the contaminant fraction of fractionation (i−1).

A best mode for multistage sequential concentration with degradation (M-SCwDR) for a supply of water with a starting concentration of greater than 50 ng/L and less than 101 ng/L of perfluorooctanoic acid and a starting concentration of greater than 50 ng/L and less than 101 ng/L of perfluorobutane sulfonate is as follows:
SCwDR processes consist of six foam fractionation processes arranged sequentially and a PCD process. A first foam fractionation process yields a separation efficiency greater than 99%. Each foam fractionation process 2 through 6 yields a separation efficiency greater than 90% and a concentration factor of greater than or equal to 9. A PCD system is operated in continuous mode comprising 2.5 g/L of hexagonal boron nitride photocatalyst and UV-C lamps with optical output more than 150 W/L, with constants a=105×10³ and b=−1×10⁶ for Equation 2 and a maximal degradation rate concentration of Cₘₐₓ=10×10⁶ ng/L.
A number of stages is at least 8.
Residence times for a PCD system in each stage are at least 15, 7, 2, and 1 minutes for stages 1 and 5, 2 and 6, 3 and 7, and 4 and 8, respectively.

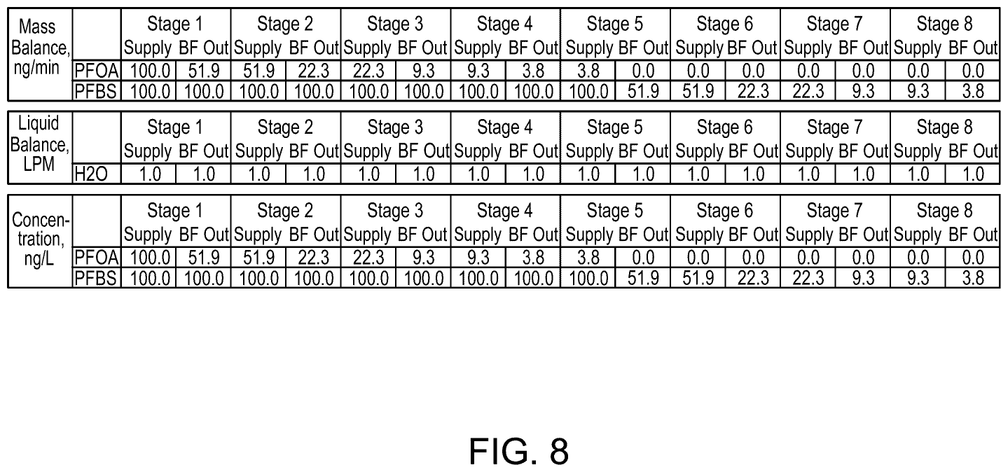

FIG. 8 contains a table showing concentrations of contaminants output from each process stage.

In some embodiments in accordance with the first aspect of the present invention, and in some embodiments in accordance with the second aspect of the present invention:
the system comprises a series of stages comprising the first stage and at least one additional stage, the series of stages starting with the first stage and ending with a last stage,
each of the at least one additional stage comprises a respective contaminant concentration sub-stage and a PCD sub-stage,
each contaminant concentration sub-stage comprises a respective first inlet, a respective first outlet and a respective second outlet,
each contaminant concentration sub-stage is configured to:
   receive fluid through its first inlet;
   output from its first outlet a respective first portion comprising a first concentration of the first contaminant;
   output from its second outlet a respective second portion comprising a second concentration of the first contaminant, the respective first concentration of the first contaminant greater than the respective second concentration of the first contaminant;
each PCD sub-stage comprises a respective PCD vessel and a respective photocatalyst in the respective PCD vessel,
each PCD vessel comprises a respective PCD-vessel first inlet,
each PCD sub-stage has a respective PCD-sub-stage outlet,
for at least one stage in the series of stages, the respective PCD-sub-stage outlet is fluid-flow connected to a contaminant-concentration-sub-stage inlet of the contaminant concentration sub-stage for that stage.

In some of such embodiments, for each stage in the series of stages, the respective PCD-sub-stage outlet is fluid-flow connected to a contaminant-concentration-sub-stage inlet of the contaminant concentration sub-stage for that stage.

In some of such embodiments:
each contaminant concentration sub-stage comprises a series of at least two fractionation columns starting with a first fractionation column and ending with a fast fractionation column,
for each series of fractionation columns, each fractionation column in that series of fractionation columns comprises a contaminant-fraction outlet and a base-fraction outlet,
for each series of fractionation columns, for each fractionation column in that series of fractionation columns except for the last fractionation column, the contaminant-fraction outlet is fluid-flow connected to an inlet of a fractionation column that is next in that series of fractionation columns,
for each series of fractionation columns, a contaminant-fraction outlet of the last fractionation column in that series is fluid-flow connected to an inlet of the PCD vessel in the same stage.

In some embodiments in accordance with the first aspect of the present invention, and in some embodiments in accordance with the second aspect of the present invention:
the first contaminant concentration sub-stage comprises a plurality of fractionation columns, the plurality of fractionation columns comprising a first series of fractionation columns starting with a first fractionation column and ending with a last fractionation column,
each fractionation column in the first series of fractionation columns comprises a contaminant-fraction outlet and a base-fraction outlet,
for each fractionation column in the first series of fractionation columns except for the last fractionation column, the contaminant-fraction outlet is fluid-flow connected to an inlet of a fractionation column that is next in the first series of fractionation columns,
a contaminant-fraction outlet of the last fractionation column is fluid-flow connected to an inlet of the first PCD vessel,
for at least one of the fractionation columns in the first series of fractionation columns, the base-fraction outlet is fluid-flow connected to an inlet of a fractionation column that is prior in the first series of fractionation columns.

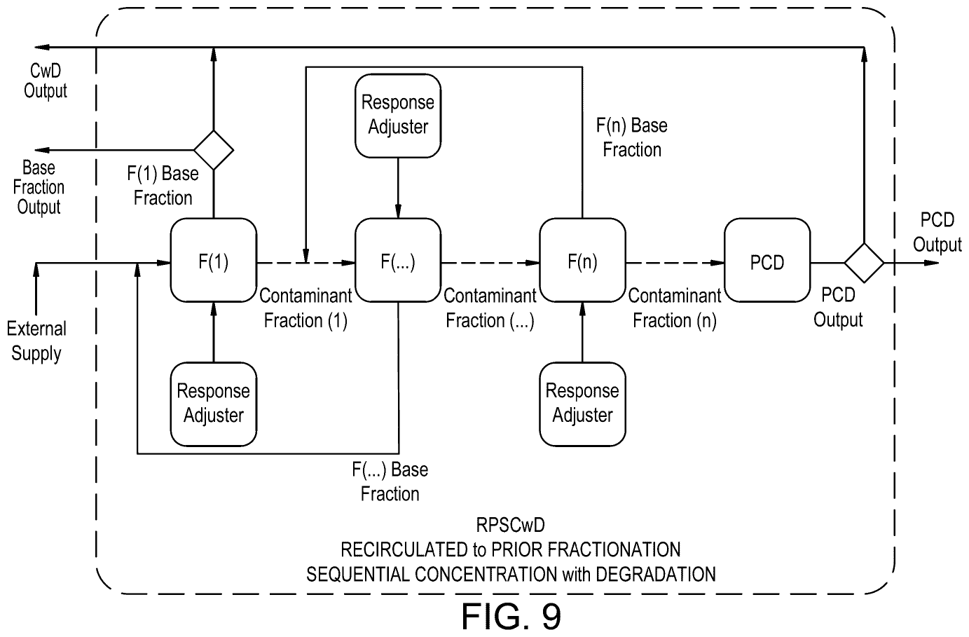

FIG. 9 depicts an embodiment of such a system and method.

In some of such embodiments, for each of the fractionation columns in the first series of fractionation columns except for the first fractionation column, the base-fraction outlet is fluid-flow connected to an inlet of a fractionation column that is prior in the first series of fractionation columns.

In some of such embodiments:
the system comprises a series of stages comprising the first stage and at least one additional stage,
each of the at least one additional stage comprises a respective contaminant concentration sub-stage and a PCD sub-stage,
each contaminant concentration sub-stage comprises a respective first inlet, a respective first outlet and a respective second outlet,
each contaminant concentration sub-stage is configured to:

receive fluid through its first inlet;
output from its first outlet a respective first portion comprising a first concentration of the first contaminant;
output from its second outlet a respective second portion comprising a second concentration of the first contaminant, the respective first concentration of the first contaminant greater than the respective second concentration of the first contaminant;
each PCD sub-stage comprises a respective PCD vessel and a respective photocatalyst in the respective PCD vessel, and
each PCD vessel comprises a respective PCD-vessel first inlet and a respective PCD-vessel first outlet, and in some of those embodiments;
each contaminant concentration sub-stage comprises a respective series of fractionation columns starting with a respective first fractionation column and ending with a respective last fractionation column,
each fractionation column in each respective series of fractionation columns comprises a respective contaminant-fraction outlet and a respective base-fraction outlet,
in each respective series of fractionation columns, for each fractionation column except for the last fractionation column, the contaminant-fraction outlet is fluid-flow connected to an inlet of a fractionation column that is next in the respective series of fractionation columns.
for each series of fractionation columns, a contaminant-fraction outlet of the last fractionation column is fluid-flow connected to an inlet of a PCD vessel,
for at least one of the fractionation columns in each series of fractionation, columns, the base-fraction outlet is fluid-flow connected to an inlet of a fractionation column that is prior in that series of fractionation columns,
   or:
for each fractionation column in each series of fractionation columns, the base-fraction outlet is fluid-flow connected to an inlet of a fractionation column that is prior in that series of fractionation columns.

FIG. 9 depicts a recirculated to prior fractionation sequential concentration with degradation (RPSCwD) system and method.

In some situations, SCwD fractionation separation efficiencies may be insufficient to achieve a target concentration.

An RPSCwD system and method as depicted in FIG. 9 can be particularly effective as a system and method that degrades contaminants and achieves a net output less than or equal to target concentrations for contaminants of similar responsiveness while operating PCD at a maximal efficiency.

As shown in FIG. 9, RPSCwD is a method utilizing sequential fractionations with base fractions recirculated to a prior fractionation with response adjuster(1) through response adjuster(n), outputs of an F(1) base fraction, a PCD output, and a CwD output where an F(1) base fraction and PCD output can have none, some, or all directed to a CwD output.

The system outputs are limited to a first fractionation base fraction and a PCD output by recirculating base fractions 2 through n to a prior fractionation. A first fractionation and a PCD are operated in a mode to achieve a net output less than a target concentration.

A best mode for RPSCwD for a supply of water with a starting concentration of greater than 50 ng/L and less than 101 ng/L of perfluorooctanoic acid is as follows:
A PCD process is operated with a residence time of at least 21 minutes in continuous mode. A PCD process comprises 2.5 g/L of hexagonal boron nitride photocatalyst and UV-C lamps with optical output more than 150 W/L, with constants a=105×10³ and b=−1×10⁶ for Equation 2 and a maximal degradation rate concentration of Cₘₐₓ=10×10⁶ ng/L.
Six foam fractionation processes are arranged sequentially, A first foam fractionation process yields a separation efficiency greater than 99%. Each foam fractionation process 2 through 6 yields a separation efficiency greater than 90% and a concentration factor of greater than or equal to 9.

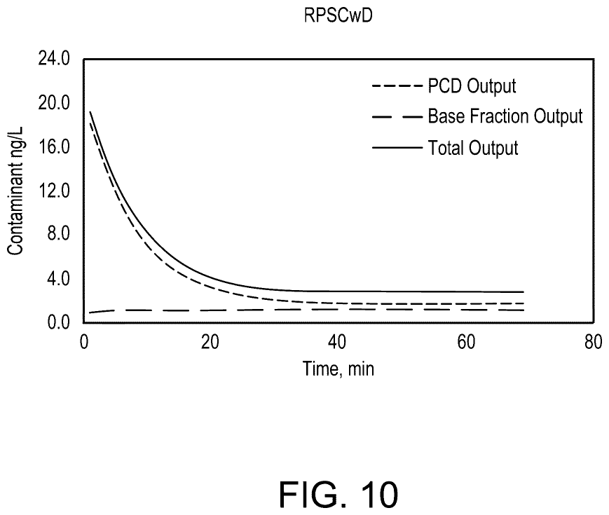

FIG. 10 contains a chart showing a concentration of a contaminant output from process initiation to stabilization.

In some embodiments in accordance with the first aspect of the present invention, and in some embodiments in accordance with the second aspect of the present invention:
the first contaminant concentration sub-stage comprises a plurality of fractionation columns, the plurality of fractionation columns comprising a first series of fractionation columns starting with a first fractionation column and ending with a last fractionation column,
each fractionation column in the first series of fractionation columns comprises a contaminant-fraction outlet and a base-fraction outlet.
for each fractionation column in the first series of fractionation columns except for the last fractionation column, the contaminant-fraction outlet is fluid-flow connected to an inlet of a fractionation column that is next in the first series of fractionation columns,
a contaminant-fraction outlet of the last fractionation column is fluid-flow connected to an inlet of the first PCD vessel, and
for at least one of the fractionation columns in the first series of fractionation columns, the base-fraction outlet is fluid-flow connected to an inlet of the first fractionation column.

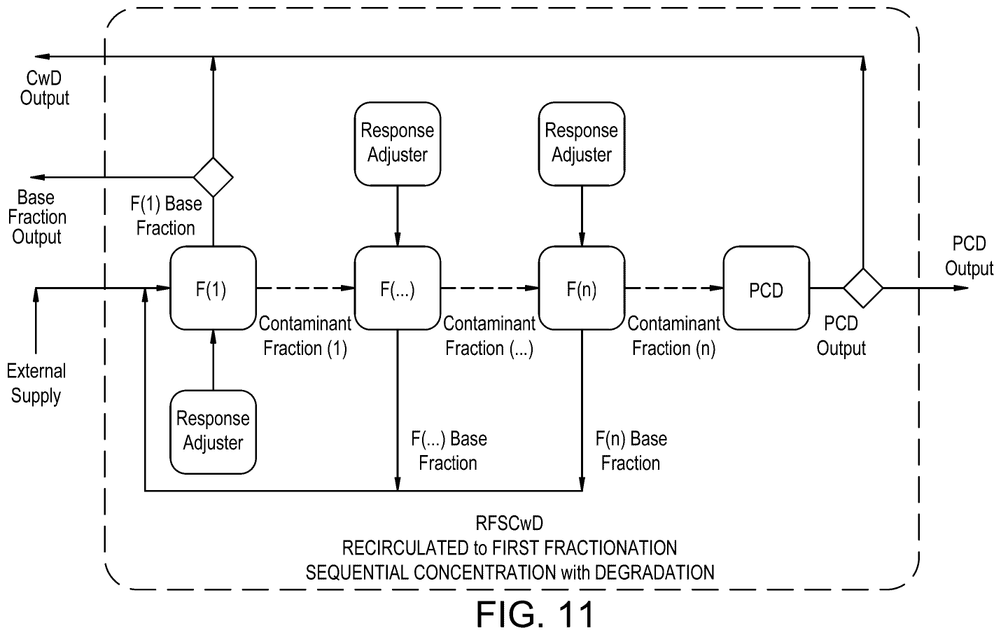

FIG. 11 depicts an embodiment of such a system and method.

In some of such embodiments, for each of the fractionation columns in the first series of fractionation columns except for the first fractionation column, the base-fraction outlet is fluid-flow connected to an inlet of the first fractionation column.

In some of such embodiments:
the system comprises a series of stages comprising the first stage and at least one additional stage,
each of the at least one additional stage comprises a respective contaminant concentration sub-stage and a PCD sub-stage,
each contaminant concentration sub-stage comprises a respective first inlet, a respective first outlet and a respective second outlet,
each contaminant concentration sub-stage is configured to:
   receive fluid through its first inlet;
   output from its first outlet a respective first portion comprising a first concentration of the first contaminant;
   output from its second outlet a respective second portion comprising a second concentration of the first contaminant, the respective first concentration of the first contaminant greater than the respective second concentration of the first contaminant;
each PCD sub-stage comprises a respective PCD vessel and a respective photocatalyst in the respective PCD vessel, and
each PCD vessel comprises a respective PCD-vessel first inlet. In some of those embodiments:
each contaminant concentration sub-stage comprises a respective series of fractionation columns starting with a respective first fractionation column and ending with a respective last fractionation column,
each fractionation column in each series of fractionation columns comprises a respective contaminant-fraction outlet and a respective base-fraction outlet,
in each series of fractionation columns, for each fractionation column except for the last fractionation column, the contaminant-fraction outlet is fluid-flow connected to an inlet of a fractionation column that is next in the series of fractionation columns,
for each series of fractionation columns, a contaminant-fraction outlet of the last fractionation column is fluid-flow connected to an inlet of a PCD vessel,
in each series of fractionation columns, for each of the fractionation columns except for the first fractionation column, the base-fraction outlet is fluid-flow connected to an inlet of the first fractionation column.

FIG. 11 depicts a recirculated to first fractionation sequential concentration with degradation (RFSCwD) system and method.

In some situations, SCwD may be insufficient to achieve a target concentration due to insufficient fractionation separation efficiencies.

An RFSCwD system and method as depicted in FIG. 11 can be particularly effective as a system and method that degrades contaminants and achieves a net output less than or equal to target concentrations for contaminants of similar responsiveness while operating PCD at a maximal efficiency.

As shown in FIG. 11, RFSCwD is a method utilizing sequential fractionations with base fractions recirculated to a first fractionation with response adjuster(1) through response adjuster(n), outputs of an F(1) base fraction, a PCD output, and a CwD output where an F(1) base fraction and PCD output can have none, some, or all directed to a CwD output.

The system outputs are limited to a first fractionation base fraction and the PCD output by recirculating base fractions 2 through n to a first fractionation. The first fractionation and the PCD are operated in a mode to achieve a net output less than a target concentration.

A best mode for RFSCwD for a supply of water with a starting concentration of greater than 50 ng/L and less than 101 ng/L of perfluorooctanoic acid is as follows:
A PCD process is operated with a residence time of at least 16 minutes in continuous mode. A PCD process comprises 2.5 g/L of hexagonal boron nitride photocatalyst and UV-C lamps with optical output more than 150 W/L, with constants a=105×10³ and b==1×10⁶ for Equation 2 and a maximal degradation rate concentration of Cₘₐₓ=10×10⁶ ng/L
Six foam fractionation processes are arranged sequentially. A first foam fractionation process yields a separation efficiency greater than 99%. Each foam fractionation process 2 through 6 yields a separation efficiency greater than 90% and a concentration factor of greater than or equal to 9.

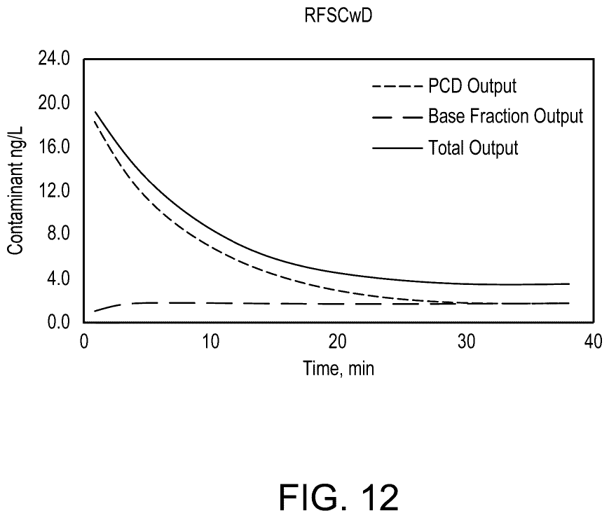

FIG. 12 contains a chart showing a concentration of a contaminant output from process initiation to stabilization.

In some embodiments in accordance with the first aspect of the present invention, and in some embodiments in accordance with the second aspect of the present invention:
the first contaminant concentration sub-stage comprises a plurality of fractionation columns, the plurality of fractionation columns comprising a first series of fractionation columns starting with a first fractionation column and ending with a last fractionation column,
each fractionation column in the first series of fractionation columns comprises a contaminant-fraction outlet and a base-fraction outlet,
for each fractionation column in the first series of fractionation columns except for the last fractionation column, the contaminant-fraction outlet is fluid-flow connected to an inlet of a fractionation column that is next in the first series of fractionation columns,
a contaminant-fraction outlet of the last fractionation column is fluid-flow connected to an inlet of the first PCD vessel, and
a PCD outlet of the first PCD sub-stage is fluid-flow connected to an inlet of a prior fractionation column in the first series of fractionation columns.

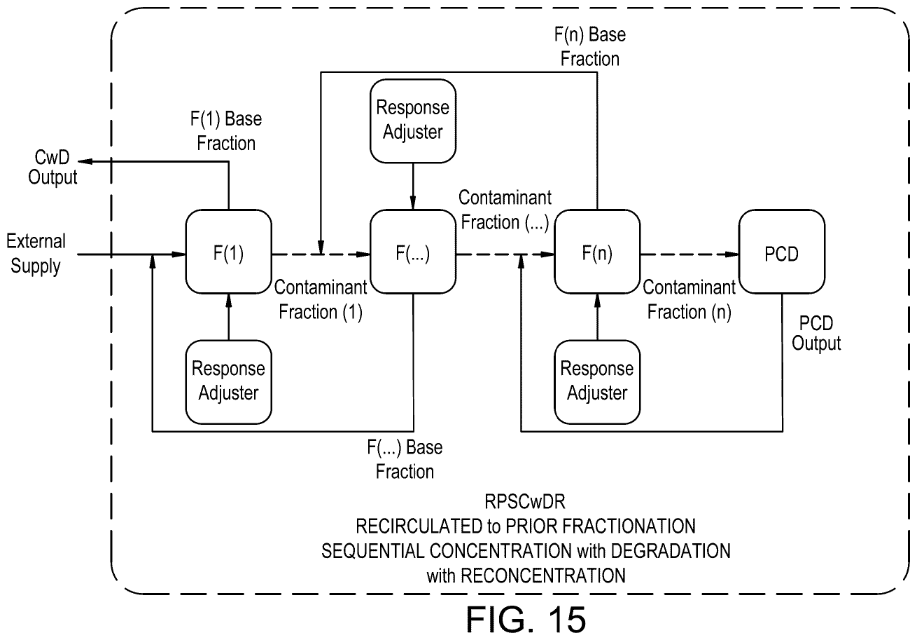

FIG. 15 depicts an embodiment of such a system and method.

In some of such embodiments, for at least one of the fractionation columns in the first series of fractionation columns, the base-fraction outlet is fluid-flow connected to an inlet of a fractionation column that is prior in the first series of fractionation columns.

In some of such embodiments, for each of the fractionation columns in the first series of fractionation columns except for the first fractionation column, the base-fraction outlet is fluid-flow connected to an inlet of a fractionation column that is prior in the first series of fractionation columns.

In some of such embodiments:
the system comprises a series of stages comprising the first stage and at least one additional stage,
each of the at least one additional stage comprises a respective contaminant concentration sub-stage and a PCD sub-stage,
each contaminant concentration sub-stage comprises a respective first inlet, a respective first outlet and a respective second outlet,
each contaminant concentration sub-stage is configured to:
   receive fluid through its first inlet;
   output from its first outlet a respective first portion comprising a first concentration of the first contaminant;
   output from its second outlet a respective second portion comprising a second concentration of the first contaminant, the respective first concentration of the first contaminant greater than the respective second concentration of the first contaminant;
each PCD sub-stage comprises a respective PCD vessel and a respective photocatalyst in the respective PCD vessel, and
each PCD vessel comprises a respective PCD-vessel first inlet. In some of those embodiments:
for each of the stages, a PCD outlet of a PCD sub-stage of that stage is fluid-flow connected to an inlet of a prior fractionation column in the first series of fractionation columns,
   and/or:
each contaminant concentration sub-stage comprises a respective series of fractionation columns starting with a respective first fractionation column and ending with a respective last fractionation column,
each fractionation column in each respective series of fractionation columns comprises a respective contaminant-fraction outlet and a respective base-fraction outlet,
in each series of fractionation columns, for each fractionation column except for the last fractionation column, the contaminant-fraction outlet is fluid-flow connected to an inlet of a fractionation column that is next in the series of fractionation columns,
for each series of fractionation columns, a contaminant-fraction outlet of the last fractionation column is fluid-flow connected to an inlet of a PCD vessel,
for at least one of the fractionation columns in the first series of fractionation columns, the base-fraction outlet is fluid-flow connected to an inlet of a fractionation column that is prior in the first series of fractionation columns,
   and/or:
for each of the fractionation columns in the first series of fractionation columns except for the first fractionation column, the base-fraction outlet is fluid-flow connected to an inlet of a fractionation column that is prior in the first series of fractionation columns.

FIG. 15 depicts a recirculated to prior fractionation sequential concentration with degradation with re-concentration (RPSCwDR) system and method.

In some situations, a RPSCwD process does not operate PCD at maximum efficiency.

An RPSCwDR system and method as depicted in FIG. 15 can be particularly effective as a system and method that degrades contaminants and achieves a net output equal to target concentrations for contaminants of similar responsiveness while operating PCD at a maximum efficiency.

As shown in FIG. 15, RPSCwDR is a method utilizing sequential fractionations with, response adjuster(1) through response adjuster(n), F(2) through F(n) base fractions and a PCD output recirculated to a prior fractionation with F(1) base fraction feeding a CwD output.

PCD efficiency is maximum when the contaminant concentration in the PCD is also a maximum. PCD contaminant concentration is maintained at a maximum by operating in continuous mode and at a residence time to continually replenish the concentration such that the degradation rate is at least the rate at which contaminants are introduced to the system. A PCD output, higher than a target concentration, is returned to a prior fractionation. The return of a PCD output contains and provides for reconcentration of contaminants.

A best mode for RPSCwDR for a supply of water with a starting concentration of greater than 50 ng/L and less than 101 ng/L of perfluorooctanoic acid is as follows:
A PCD process is operated with a residence time of at least 19 minutes in continuous mode. A PCD process comprises 2.5 g/L of hexagonal boron nitride photocatalyst and UV-C lamps with optical output more than 150 W/L, with constants a=105×10³ and b==1×10⁶ for Equation 2 and a maximal degradation rate concentration of Cmx=10×10⁶ ng/L.
Six foam fractionation processes are arranged sequentially. A first foam fractionation process yields a separation efficiency greater than 99%. Each foam fractionation process 2 through 6 yields a separation efficiency greater than 90% and a concentration factor of greater than or equal to 9.

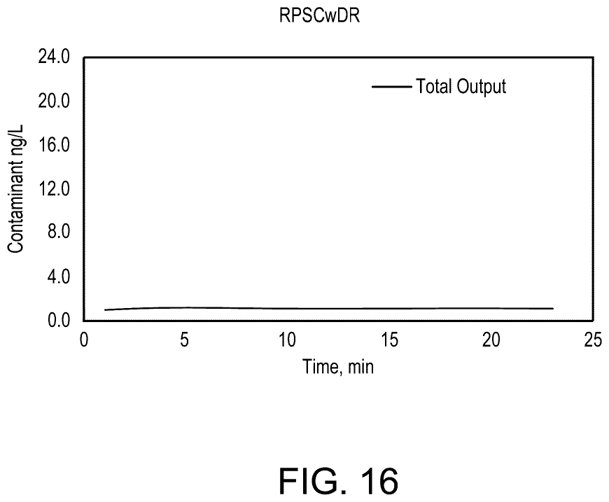

FIG. 16 contains a chart showing a concentration of a contaminant output from process initiation to stabilization.

In some embodiments in accordance with the first aspect of the present invention, and in some embodiments in accordance with the second aspect of the present invention:
the first contaminant concentration sub-stage comprises a plurality of fractionation columns, the plurality of fractionation columns comprising a first series of fractionation columns starting with a first fractionation column and ending with a last fractionation column,
each fractionation column in the first series of fractionation columns comprises contaminant-fraction outlet and a base-fraction outlet,
for each fractionation column in the first series of fractionation columns except for the last fractionation column, the contaminant-fraction outlet is fluid-flow connected to an inlet of a fractionation column that is next in the first series of fractionation columns,
a contaminant-fraction outlet of the last fractionation column is fluid-flow connected to an inlet of the first PCD vessel, a PCD outlet of the PCD sub-stage is fluid-flow connected to an inlet of the first fractionation column.

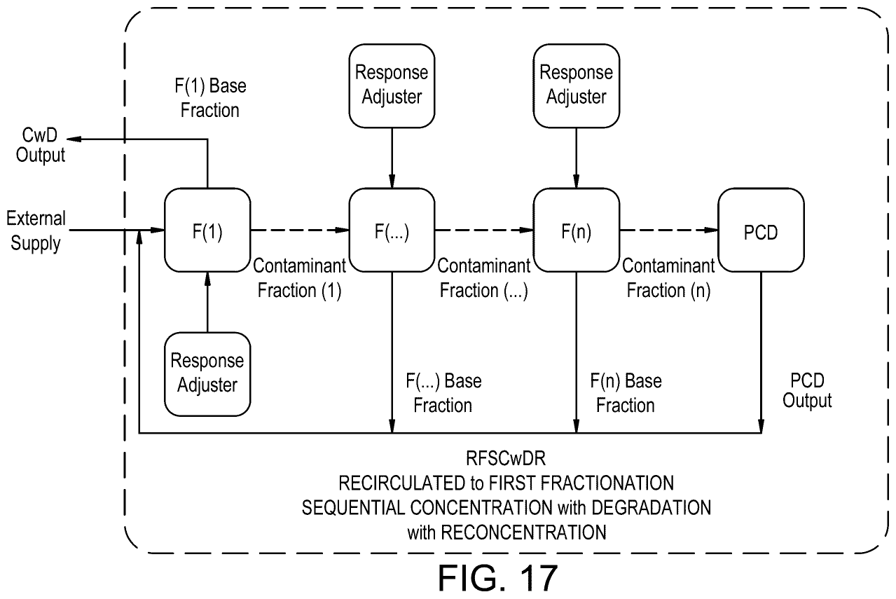

FIG. 17 depicts an embodiment of such a system and method.

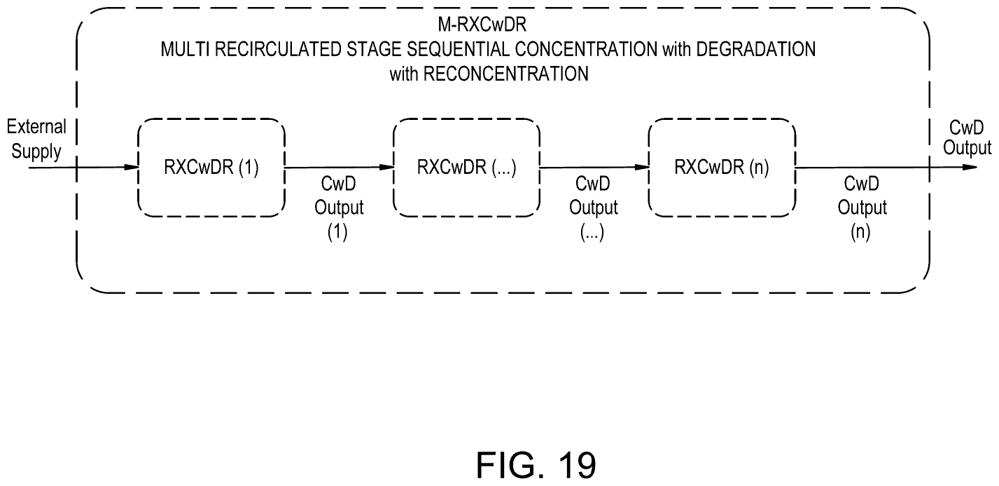

In some of such embodiments:
the system comprises a series of stages comprising the first stage and at least one additional stage,
each of the at least one additional stage comprises a respective contaminant concentration sub-stage and a PCD sub-stage,
each contaminant concentration sub-stage comprises a respective first inlet, a respective first outlet and a respective second outlet,
each contaminant concentration sub-stage is configured to:
   receive fluid through its first inlet;
   output from its first outlet a respective first portion comprising a first concentration of the first contaminant;
   output from its second outlet a respective second portion comprising a second concentration of the first contaminant, the respective first concentration of the first contaminant greater than the respective second concentration of the first contaminant;
each PCD sub-stage comprises a respective PCD vessel and a respective photocatalyst in the respective PCD vessel, and
each PCD vessel comprises a respective PCD-vessel first inlet. In some of those embodiments:
each contaminant concentration sub-stage comprises a respective series of fractionation columns starting with a respective first fractionation column and ending with a respective last fractionation column,
each fractionation column in each respective series of fractionation columns comprises a respective contaminant-fraction outlet and a respective base-fraction outlet,
in each series of fractionation columns, for each fractionation column except for the last fractionation column, the contaminant-fraction outlet is fluid-flow connected to an inlet of a fractionation column that is next in the series of fractionation columns,
for each series of fractionation columns, a contaminant-fraction outlet of the last fractionation column is fluid-flow connected to an inlet of a PCD vessel, and
for each stage in the series of stages, a PCD outlet of a PCD sub-stage of that stage is fluid-flow connected to an inlet of a first fractionation column of that stage,
   and/or:
for at least one of the fractionation columns in each respective series of fractionation columns, the base-fraction outlet is fluid-flow connected to an inlet of a fractionation column that is prior in that series of fractionation columns,
   and/or:
for each of the fractionation columns in at least one of the respective series of fractionation columns, except for the first fractionation column in each series of fractionation columns, the base-fraction outlet is fluid-flow connected to an inlet of a fractionation column that is prior in that series of fractionation columns,
   and/or:
for each of the fractionation columns in each respective series of fractionation columns, except for the first fractionation column in each series of fractionation columns, the base-fraction outlet is fluid-flow connected to an inlet of a fractionation column that is prior in that series of fractionation columns,
   and/or:
for at least one of the fractionation columns in each respective series of fractionation columns, the base-fraction outlet is fluid-flow connected to an inlet of the first fractionation column in that series of fractionation columns,
   and/or:
for each of the fractionation columns in at least one of the respective series of fractionation columns, except for the first fractionation column in each series of fractionation columns, the base-fraction outlet is fluid-flow connected to an inlet of the first fractionation column in that series of fractionation columns,
   and/or:
for each of the fractionation columns in each respective series of fractionation columns, except for the first fractionation column in each series of fractionation columns, the base-fraction outlet is fluid-flow connected to an inlet of the first fractionation column in that series of fractionation columns,
   and/or:
for each stage in the series of stages except for the last stage, a base-fraction outlet of the first fractionation column in that stage is fluid-flow connected to a contaminant concentration sub-stage of a stage that is next in the series of stages (FIG. 19 depicts an embodiment of such a system and method),
   and/or:
for each stage in the series of stages except for the last stage, a base-fraction outlet of at least one fractionation column in that stage is fluid-flow connected to a contaminant concentration sub-stage of a stage that is next in the series of stages (FIG. 19 depicts an embodiment of such a system and method).

FIG. 17 depicts a recirculated to first fractionation sequential concentration with degradation with re-concentration (RFSCwDR) system and method.

In some situations, a RFSCwD process does not operate PCD at maximum efficiency.

An RFSCwDR system and method as depicted in FIG. 17 can be particularly effective as a system and method that degrades contaminants and achieves a net output equal to target concentrations for contaminants of similar responsiveness while operating PCD at a maximum efficiency.

As shown in FIG. 17, RFSCwDR is a method utilizing sequential fractionations with response adjuster(1) through response adjuster(n), F(2) through F(n) base fractions and a PCD output prior fractionation with F(1) base fraction feeding a CwD output.

PCD efficiency is maximum when the contaminant concentration in the PCD is also a maximum. PCD contaminant concentration is maintained at a maximum by operating in continuous mode and at a residence time to continually replenish the concentration such that the degradation rate is at least the rate at which contaminants are introduced to the system, A PCD output, higher than a target concentration, is returned to a prior fractionation. The return of a PCD output contains and provides for reconcentration of contaminants.

A best mode for RESCwDR for a supply of water with a starting concentration of greater than 50 ng/L and less than 101 ng/L of perfluorooctanoic acid is as follows:
A PCD process is operated with a residence time of at least 16 minutes in continuous mode. A PCD process comprises 2.5 g/L of hexagonal boron nitride photocatalyst and UV-C lamps with optical output more than 150 W/L, with constants a=105×10³ and b=−1×10⁶ for Equation 2 and a maximal degradation rate concentration of Cₘₐₓ=10×10⁶ ng/L.
Six foam fractionation processes are arranged sequentially. A first foam fractionation process yields a separation efficiency greater than 99%. Each foam fractionation process 2 through 6 yields a separation efficiency greater than 90% and a concentration factor of greater than or equal to 9.

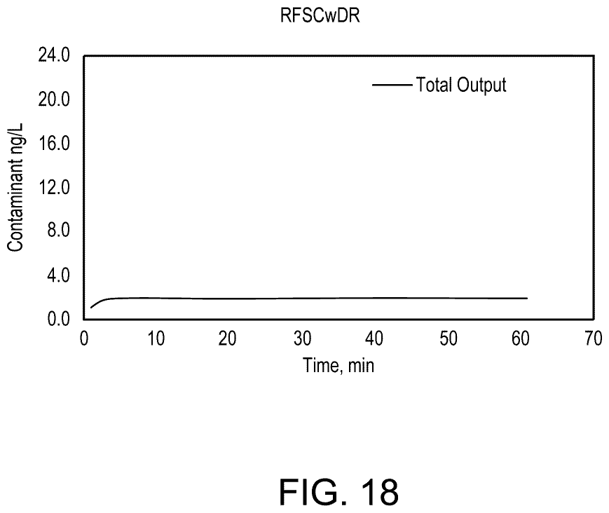

FIG. 18 contains a chart showing a concentration of a contaminant output from process initiation to stabilization.

FIG. 19 depicts a multistage recirculated to X fractionation sequential concentration with degradation (M-RXSCwDR) system and method.

In some situations, RPSCwDR and RFSCwDR processes may discharge lower responsiveness contaminants in a first fractionation base fraction and a PCD output.

An M-RXSCwDR system and method as depicted in FIG. 19 can be particularly effective as a system and method that degrades contaminants and achieves a net output less than or equal to target concentrations for contaminants of multiple responsiveness while operating PCD at a maximum efficiency.

As shown in FIG. 19, M-RXSCwDR is a method utilizing sequential RXSCwDR processes with outputs CwD Outputs (i), where i=1 to n, with a final RXSCwDR having a CwD outputs (n) directed to a CwD output.

Base fractions discharged from RXSCwDR processes are contained and input into a supply of a sequential RXSCwDR process. RXSCwDR processes progressively degrade contaminants according to responsiveness. A number of sequential RXSCwDR processes produce a concentration comprising a last fractionation output less than or equal to target concentrations of multiple responsive contaminants.

A best mode for M-RXSCwDR for a supply of water with a starting concentration of greater than 50 ng/L and less than 101 ng/L of perfluorooctanoic acid and a starting concentration of greater than 50 ng/L and less than 101 ng/L of perfluorobutane sulfonate is as follows:
Sequential RFSCwDR processes consist of six foam fractionations arranged sequentially and a PCD process. A first foam fractionation process yields a separation efficiency greater than 99%. Each foam fractionation process 2 through 6 yields a separation efficiency greater than 90% and a concentration factor of greater than or equal to 9. A PCD system operated in continuous mode comprising 2.5 g/L of hexagonal boron nitride photocatalyst and UV-C lamps with optical output more than 150 W/L, with constants a=105×10³ and b=−1×10⁶ for Equation 2 and a maximal degradation rate concentration of Cₘₐₓ=10×10⁶ ng/L.
A number of sequential RFSCwDR processes is at least 2.

Residence times for a PCD system in each stage are at least 16 minutes, for stages 1 and 2.

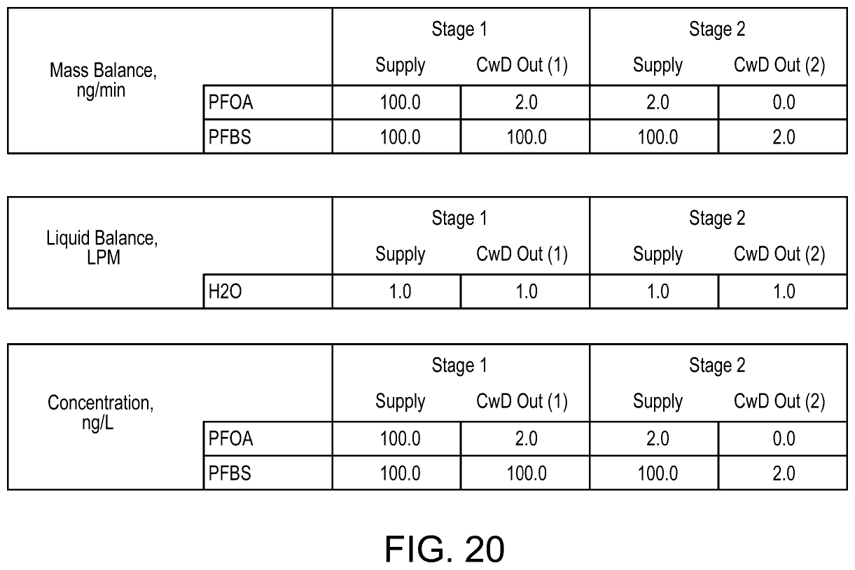

FIG. 20 contains a table showing concentrations of contaminants output from each process stage.

In some embodiments in accordance with the first aspect of the present invention, and in some embodiments in accordance with the second aspect of the present invention:
the first contaminant concentration sub-stage comprises a plurality of fractionation columns, the plurality of fractionation columns comprising a first series of fractionation columns starting with a first fractionation column and ending with a last fractionation column,
each fractionation column in the first series of fractionation columns comprises a contaminant-fraction outlet and a base-fraction outlet,
for each fractionation column in the first series of fractionation columns except for the last fractionation column, the contaminant-fraction outlet is fluid-flow connected to an inlet of a fractionation column that is next in the first series of fractionation columns,
a contaminant-fraction outlet of the last fractionation column is fluid-flow connected to an inlet of the first PCD vessel,
a PCD outlet of the PCD sub-stage is fluid-flow connected to an inlet of the first fractionation column, and
for at least one of the fractionation columns in the first series of fractionation, columns, the base-fraction outlet is fluid-flow connected to the first fractionation column.

In some of such embodiments:
for each of the fractionation columns in the first series of fractionation columns, the base-fraction outlet is fluid-flow connected to the first fractionation column.

In some embodiments in accordance with the first aspect of the present invention, and in some embodiments in accordance with the second aspect of the present invention;
the system further comprises at least a first serial-separation stage, the first serial-separation stage comprising a first series of separation-stage fractionation columns starting with a first separation-stage fractionation column and ending with a last separation-stage fractionation column,
each separation-stage fractionation column in the first series of separation-stage fractionation columns comprises a separation-stage-contaminant-fraction outlet and a separation-stage-base-fraction outlet,
for each separation-stage fractionation column in the first series of separation-stage fractionation columns except for the last separation-stage fractionation column, the base-fraction outlet from that separation-stage fractionation column is fluid-flow connected to a next separation-stage fractionation column in the first series of separation-stage fractionation columns,
a separation-stage-contaminant-fraction outlet of at least one of the separation-stage fractionation columns is fluid-flow connected to the first-contaminant-concentration-sub-stage first inlet.

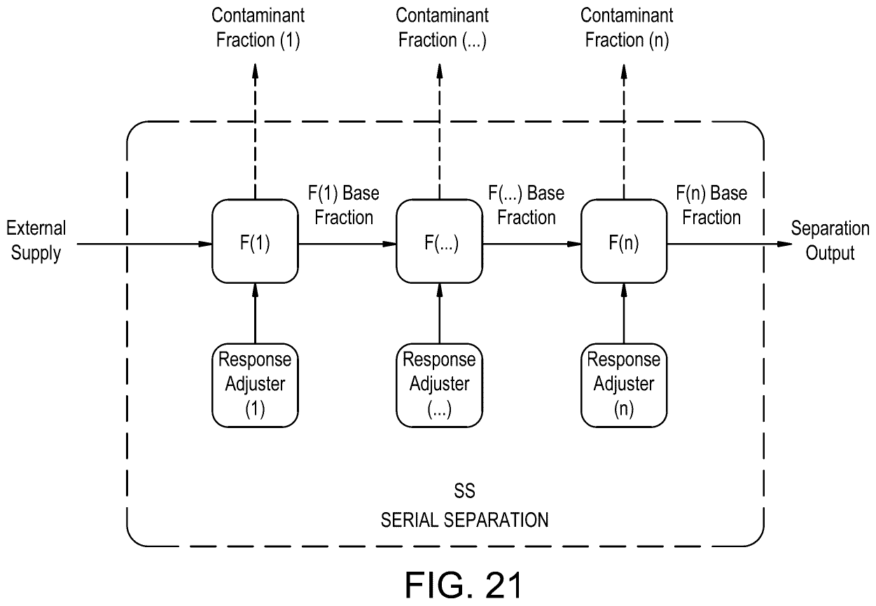

FIG. 21 depicts an embodiment of such a system and method.

FIG. 21 depicts a serial separation (SS) system and method.

In some situations, batch and continuous modes of fractionation do not separate lower responsiveness contaminants to low concentrations when higher responsiveness contaminants are present, Batch mode fractionation efficacy can decrease with time as process dynamics shift. In foam fractionation, for example, lower separation efficiency results from the water height in the water column reducing as a foam fraction evolves from the process. Continuous mode separation efficiency is limited by replenishment of contaminants. In foam fractionation, for example, this leads to longer residence time to achieve a target Base Fraction concentration.

An SS system and method as depicted in FIG. 21 can be particularly effective as a system and method that discharges a base fraction with contaminant concentrations less than or equal to targets for multiple responsiveness contaminants and segregates multiple responsiveness contaminants into separate contaminant fractions in a minimal time.

As shown in FIG. 21, SS is a method utilizing serial fractionations with outputs of F(1) through F(n) contaminant fractions, response adjuster(1) through response adjuster(n), F(1) through F(n−1) base fractions feeding a next fractionation, and an F(n) base fraction feeding a separation output.

Serial arrangement of fractionations limits replenishment. In a batch mode operation, transfer of a base fraction to a next fractionation prevents replenishment. In a continuous mode operation, the output base fractions' concentrations are progressively reduced in each fractionation by the differences between amounts of incoming contaminants and that separated into the foam. Response adjusters may be added in each fractionation to enhance separation efficiencies for all or specific contaminants.

A best mode for serial separation for a supply of water with a starting concentration of greater than 50 ng/L and less than 101 ng/L of perfluorooctanoic acid and a starting concentration of greater than 50 ng/L and less than 101 ng/L of perfluorobutane sulfonate, with an output of both contaminants reduced to less than or equal to 4 ng/L, is as follows:
Five foam fractionation processes are arranged serially. A supply rate is set achieve a first fractionation dwell time of at least 1.5 minutes, Response adjuster CTAB is added to fractionations 4 and 5 at a concentration of 5 mM.

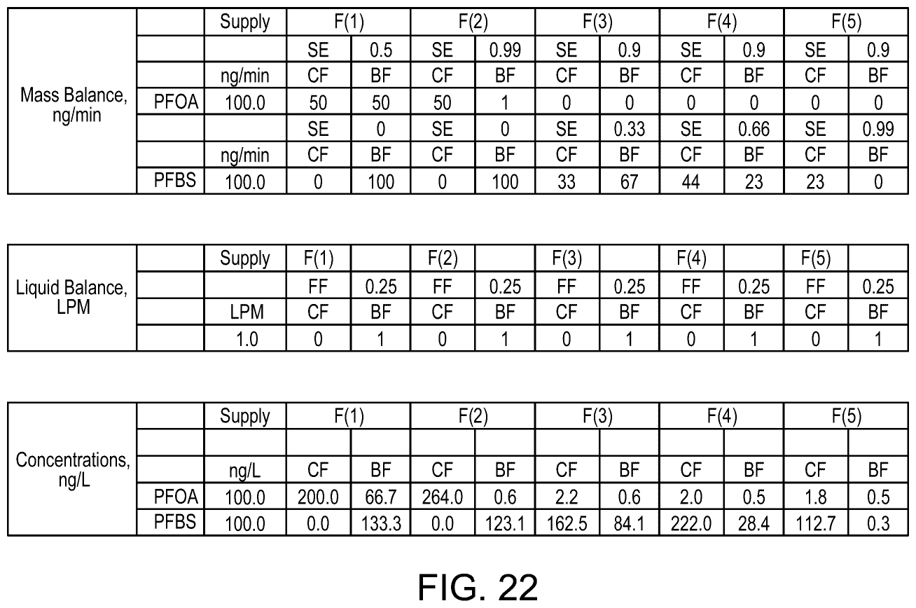

FIG. 22 contains a table showing a mass balance of contaminants through SS.

In some embodiments in accordance with the first aspect of the present invention, and in some embodiments in accordance with the second aspect of the present invention:
the system further comprises at least a first serial-separation stage, the first serial-separation stage comprising a first series of separation-stage fractionation columns starting with a first separation-stage fractionation column and ending with a last separation-stage fractionation column,
each separation-stage fractionation column in the first series of separation-stage fractionation columns comprises at least one separation-stage inlet, a separation-stage-contaminant-fraction outlet and a separation-stage-base-fraction outlet,
for each separation-stage fractionation column in the first series of separation-stage fractionation columns except for the last separation-stage fractionation column, the base-fraction outlet from that separation-stage fractionation column is fluid-flow connected to a next separation-stage fractionation column in the first series of separation-stage fractionation columns,
the system comprises a series of stages comprising the first stage and at least one additional stage,
each of the at least one additional stage comprises a respective contaminant concentration sub-stage and a PCD sub-stage,
each contaminant concentration sub-stage comprises at least one contamination concentration sub-stage inlet, a respective first outlet and a respective second outlet,
each contaminant concentration sub-stage is configured to:
   receive fluid through at least one contamination concentration sub-stage inlet of that contaminant concentration sub-stage;
   output from its first outlet a respective first portion comprising a first concentration of the first contaminant;
   output from its second outlet a respective second portion comprising a second concentration of the first contaminant, the respective first concentration of the first contaminant greater than the respective second concentration of the first contaminant;
each PCD sub-stage comprises a respective PCD vessel and a respective photocatalyst in the respective PCD vessel,
each PCD vessel comprises a respective PCD-vessel inlet,
each PCD sub-stage comprises a respective PCD-sub-stage outlet,
for each stage, the respective first outlet of the contaminant concentration sub-stage is fluid-flow connected to the respective PCD-vessel inlet for that stage,
each separation-stage-contaminant-fraction outlet is fluid-flow connected to the first inlet of a respective one of the contaminant concentration-sub-stages.

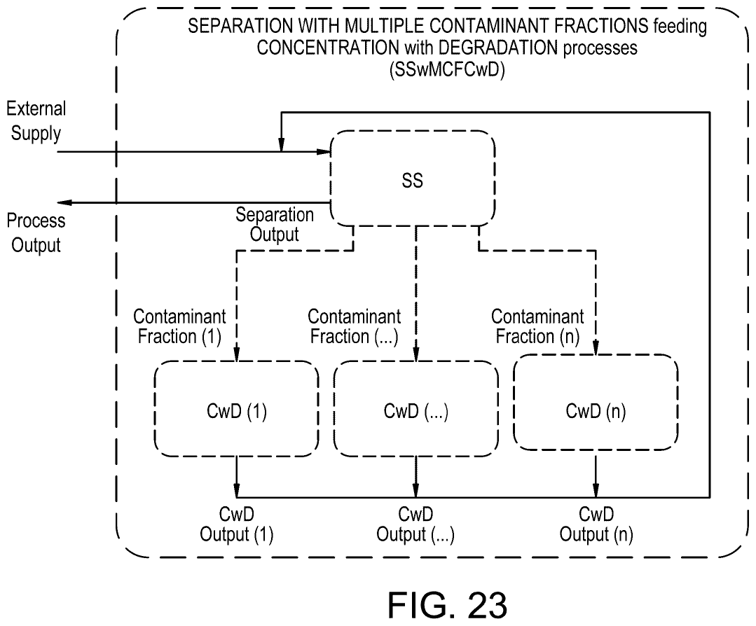

FIG. 23 depicts an embodiment of such a system and method.

In some of such embodiments;
each of the second outlets of the contaminant concentration sub-stages is fluid-flow connected to a separation-stage inlet of the first serial-separation stage, and
each of the PCD-sub-stage outlets is fluid-flow connected to a separation-stag inlet of the first serial-separation stage:

In some of such embodiments, each of the respective second outlets of the contaminant concentration sub-stages is fluid-flow connected to a separation-stage inlet of the first serial-separation stage. In some of those embodiments, for each of the series of stages except for the last stage, the PCD-sub-stage outlet for that stage is fluid-flow connected to a contaminant-concentration-sub-stage inlet for a stage that is next in the series of stages.

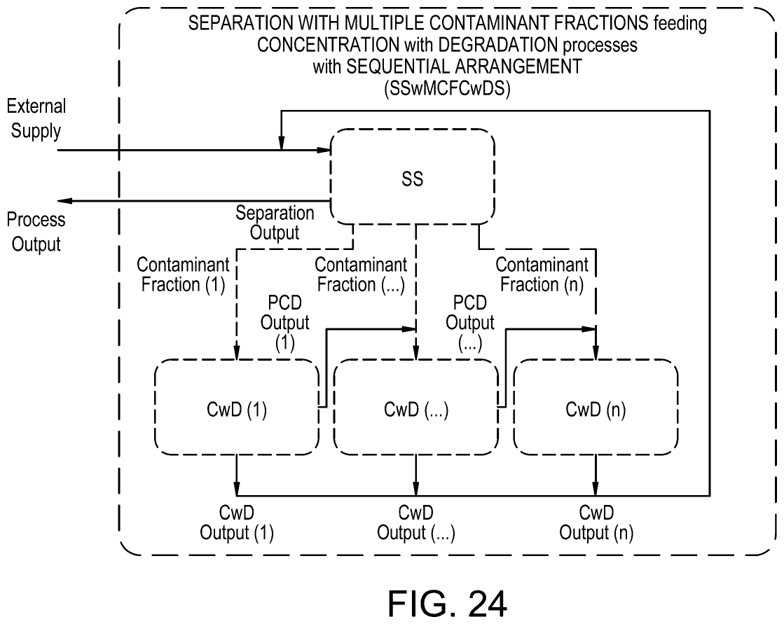

FIG. 24 depicts an embodiment of such a system and method.

In some of those embodiments, the sequence of separation-stage fractionation columns in the first series of separation-stage fractionation columns corresponds to the sequence of stages, i.e., such that the contamination-fraction outlet from the first separation-stage fractionation column is fluid-flow connected to the first stage, the contamination-fraction outlet from the second separation-stage fractionation column and the PCD outlet from the first stage feed the second stage,

and/or:
the first series of separation-stage fractionation columns comprises the first separation-stage fractionation column and at least a second separation-stage fractionation column,
the series of stages comprises the first stage and at least a second stage, the contamination-fraction outlet from the first separation-stage fractionation column is fluid-flow connected to a contamination-concentration sub-stage inlet of the first stage, and
the contamination-fraction outlet from the second separation-stage fractionation column and the PCD outlet from the first stage are fluid-flow connected to a contamination-concentration-sub-stage inlet of the second stage,
   and/or:

the first series of separation-stage fractionation columns comprises the first separation-stage fractionation column and at least second and third separation-stage fractionation columns,
the series of stages comprises the first stage and at least second and third stages,
the contamination-fraction outlet from the first separation-stage fractionation column is fluid-flow connected to a contaminant-concentration-sub-stage inlet to the first stage,
the contamination-fraction outlet from the second separation-stage fractionation column and the PCD-sub-stage outlet from the first stage are fluid-flow connected to a contaminant-concentration-sub-stage inlet to the second stage, and
the contamination-fraction outlet from the third separation-stage fractionation column and the PCD-sub-stage outlet from the second stage are fluid-flow connected to a contaminant-concentration-sub-stage inlet to the third stage,
   and/or;
for each of the series of stages except for the last stage, the PCD-sub-stage outlet for that stage is fluid-flow connected to a contaminant-concentration-sub-stage inlet for a stage that is next in the series of stages.

FIG. 23 depicts a multiple contaminant fractions feeding separate concentration with degradation (SSwMCFSCwD) system and method.

In some situations, fractionation does not degrade contaminants and produces concentrated contaminant fractions, and concentration with degradation is not efficient at separating contaminants from liquids.

An SSwMCFSCwD system and method as depicted in FIG. 23 can be particularly effective as a system and method that efficiently separates and degrades multiple responsiveness contaminants, producing an output less than or equal to a target concentration.

As shown in FIG. 23, SSwMCFSCwD is a method utilizing a SS process with an output, separation output, and contaminant fraction(1) through contaminant fraction(n) feeding CwD(1) through CwD(n), with CwD output(1) through CwD output(n) feeding a SS process.

Serial separation efficiently produces a final base fraction with concentrations less than or equal to targets and segregates contaminants by responsiveness into separate contaminant fractions that feed separate CwD processes degrading contaminants at rates greater than or equal to rates at which contaminants are supplied.

A best mode for SSwMCFSCwD for a supply of water with a starting concentration of greater than 50 ng/L and less than 101 ne/L. of perfluorooctanoic acid and a starting concentration of greater than 50 ng/L and less than 101 ng/L of perfluorobutane sulfonate, with an output of both contaminants reduced to less than or equal to 4 ng/L, is as follows:
SS comprises five foam fractionations arranged serially. A supply rate is set to achieve a first fractionation dwell time of at least 3 minutes. Response adjuster CTAB is added to fractionations 4 and 5 at a concentration of 5 mM.
Five CwD processes comprise SCwD. Each SCwD comprises a PCD system operated with a residence time of at least 17 minutes in continuous mode. A PCD system comprises 2.5 g/L of hexagonal boron nitride photocatalyst and UV-C lamps with optical output more than 150 W/L, with constants a=105×10³ and b=−1×10⁶ for Equation 2 and a maximal degradation rate concentration of Cₘₐₓ=10×10⁶ ng/L.
Each SCwD comprises five foam fractionation processes arranged sequentially. Each foam fractionation process 1 through 5 yields a separation efficiency greater than 90% and a concentration factor of greater than or equal to 9.

FIG. 24 depicts a serial separation with multiple contaminant fractions feeding separate concentration with degradation with sequential arrangement (SSwMCFSCwDS) system and method.

In some situations, fractionation does not degrade contaminants and produces concentrated contaminant fractions, and concentration with degradation is not efficient at separating contaminants from liquids.

An SSwMCFSCwDS system and method as depicted in FIG. 24 can be particularly effective as a system and method that efficiently separates and degrades multiple responsiveness contaminants, producing an output less than or equal to a target concentration.

As shown in FIG. 24, SSwMCFSCwDS is a method utilizing a SS process with an output, separation output, and contaminant fraction(1) through contaminant fraction(n) feeding CwD(1) through CwD(n), with CwD output(1) through CwD output(n−1) directed to a next CwD with a CwD output(n) feeding a SS process.

Serial separation efficiently produces a separation output with concentrations less than or equal to targets and segregates contaminants by responsiveness into separate contaminant fractions that feed separate CwD processes degrading contaminants at rates greater than or equal to rates at which contaminants are supplied.

A best mode for SSwMCFSCwDS for a supply of water with a starting concentration of greater than 50 ng/L and less than 101 ng/L of perfluorooctanoic acid and a starting concentration of greater than 50 ng/L and less than 101 ng/L of perfluorobutane sulfonate, with an output of both contaminants reduced to less than or equal to 4 ng/L, is as follows:
SS comprises five foam fractionations arranged serially. A supply rate is set to achieve a first fractionation dwell time of at least 3 minutes. Response adjuster CTAB is added to fractionations 4 and 5 at a concentration of 5 mM.
Five CwD processes comprise SCwD. Each SCwD comprises a PCD system operated with a residence time of at least 17 minutes in continuous mode. A PCD system comprises 2.5 g/L of hexagonal boron nitride photocatalyst and UV-C lamps with optical output more than 150 W/L, with constants a=105×10³ and b=−1×10⁶ for Equation 2 and a maximal degradation rate concentration of Cₘₐₓ=10×10⁶ ng/L.
Each SCwD comprises five foam fractionation processes arranged sequentially.
Each foam fractionation process 2 through 6 yields a separation efficiency greater than 90% and a concentration factor of greater than or equal to 9.

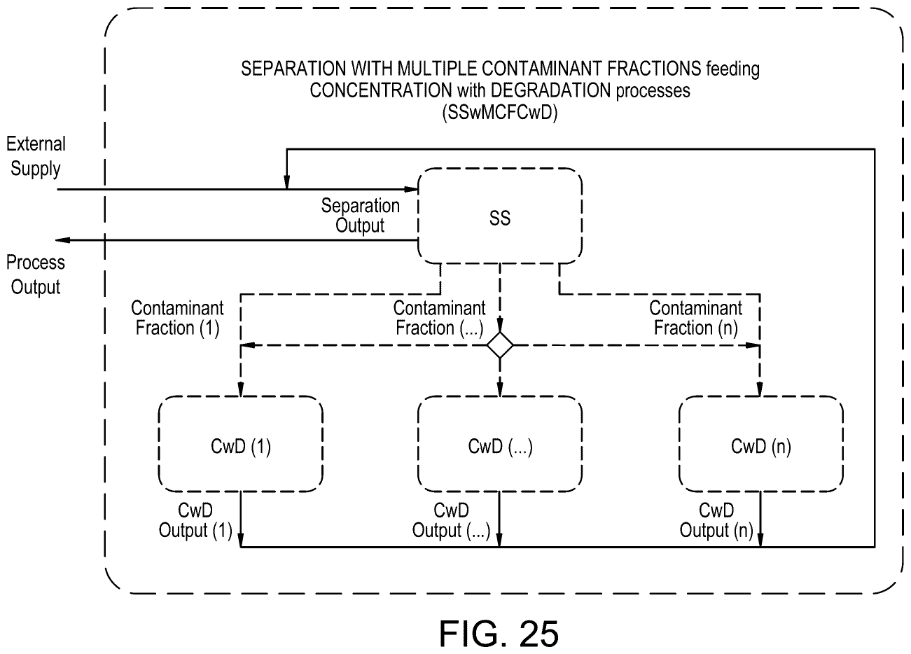

FIG. 25 depicts a serial separation with consolidations of contaminant fractions feeding concentration with degradation (SSwCCFCwD) system and method.

Fractionation does not degrade contaminants, and in some situations, concentration with degradation is not efficient at separating contaminants.

An SSwCCFCwD system and method as depicted in FIG. 25 can be particularly effective as a system and method that efficiently separates and degrades multiple responsiveness contaminants, producing an output Base Fraction below a target concentration.

As shown in FIG. 25, SSwCCFCwD is a method utilizing a SS process with an output, separation output, and contaminant fraction(1) directed to CwD(1), contaminant fraction(2) through contaminant fraction(i) each directed to CwD(1) through CwD(n) and a contaminant fraction (i) directed to CwD(n). CwD output(1) through CwD output(n) directed to a SS process.

Serial separation efficiently produces a final base fraction with concentrations less than or equal to targets and segregates contaminants by responsiveness into separate contaminant fractions that feed separate CwD processes degrading contaminants at rates greater than or equal to rates at which contaminants are supplied

A best mode for SSwCCFCwD for a supply of water with a starting concentration of greater than 50 ng/L and less than 101 ng/L of perfluorooctanoic acid and a starting concentration of greater than 50 ng/L and less than 101 ng/L of perfluorobutane sulfonate, with an output of both contaminants reduced to less than or equal to 4 ng/L, is as follows:
SS comprises five foam fractionations arranged serially. A supply rate is set to achieve a first fractionation dwell time of at least 3 minutes. Response adjuster CTAB is added to fractionations 4 and 5 at a concentration of 5 mM.
Two CwD processes each comprised of a SCwD process. Each SCwD comprises a PCD system operated with a residence time of at least 17 minutes in continuous mode. A PCD system comprises 2.5 g/L of hexagonal boron nitride photocatalyst and UV-C lamps with optical output more than 150 W/L, with constants a=105×10³ and b=−1×10⁶ for Equation 2 and a maximal degradation rate concentration of Cₘₐₓ=10×10⁶ ng/L.
Each SCwD comprises five foam fractionations. Each foam fractionation process 1 through 5 yields a separation efficiency greater than 90% and a concentration factor of greater than or equal to 9.

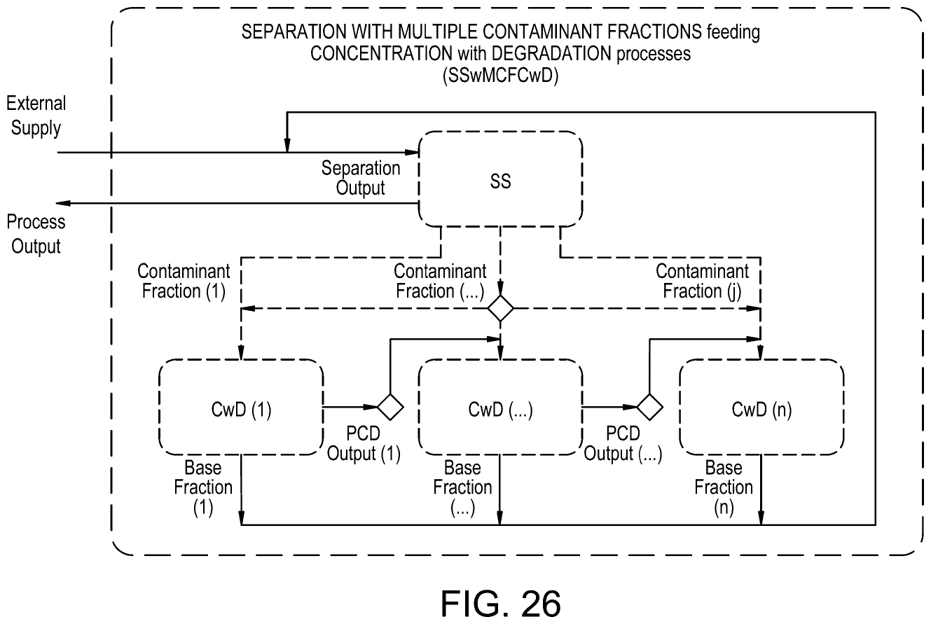

FIG. 26 depicts a serial separation with consolidations of contaminant fractions feeding concentration with degradation with sequential arrangement (SSwCCFCwDS) system and method.

Fractionation does not degrade contaminants, and in some situations, concentration with degradation is not efficient at separating contaminants.

An SSwCCFCwDS system and method as depicted in FIG. 26 can be particularly effective as a system and method that efficiently separates and degrades multiple responsiveness contaminants, producing an output Base Fraction below a target concentration.

As shown in FIG. 26, SSwCCFCwDS is a method utilizing a SS process with an output, separation output, and contaminant fraction(1) directed to CwD(1), contaminant fraction(2) through contaminant fraction (i) each directed to CwD(1) through CwD(n) and a contaminant fraction (i) directed to CwD(n). CwD output(1) through CwD output(n−1) directed to a next CwD with a CwD output(n) feeding a SS process.

Serial separation is first applied to separate contaminants efficiently and to output a base fraction with contaminant concentrations below a target. SS segregates contaminants by their responsiveness into separate contaminant fractions that are consolidated into multiple streams feeding multiple CwD processes. A CwD process can be optimized for the contaminants of the consolidated contaminant fractions.

A best mode for SSwMCFSCwD for a supply of water with a starting concentration of greater than 50 ng/L and less than 101 ng/L of perfluorooctanoic acid and a starting concentration of greater than 50 ng/L and less than 101 ng/L of perfluorobutane sulfonate, both contaminants reduced to less than or equal to 4 ng/L, is as follows:
SS comprises five foam fractionations arranged serially. A supply rate is set to achieve a first fractionation dwell time of at least 3 minutes. Response adjuster CTAB is added to fractionations 4 and 5 at a concentration of 5 mM.
Two CwD processes comprise SCwD. Each SCwD comprises a PCD system operated with a residence time of at least 17 minutes in continuous mode. A PCD system comprises 2.5 g/L of hexagonal boron nitride photocatalyst and UV-C lamps with optical output more than 150 W/L, with constants a=105×10³ and b=−1×10⁶ for Equation 2 and a maximal degradation rate concentration of Cₘₐₓ=10×10⁶ ng/L.
Each SCwD comprises five foam fractionations arranged sequentially. Each foam fractionation process 1 through 5 yields a separation efficiency greater than 90% and a concentration factor of greater than or equal to 9.

The above discussion contains references to UV-C lamps with optical output more than 150 W/L. An optical output of 150 W/L is a representative minimum optical output value to achieve degradation at a certain dwell time for a particular reactor design and operation. The objective is to maximize the optical output density (Optical Watts/Liter) regardless of the catalyst or contaminant concentration, and quantifying a maximum and minimum would not be necessary because the optical output density has to do with the statistical probability of photons of appropriate frequency hitting a catalyst with adsorbed contaminant. That probability is increased by increasing the photon density (optical watts/Liter). Therefore, for any particular catalyst, flooding the area with a maximum of photons is desirable, and a desirable maximum W/L can be determined on that basis. A desirable minimum W/L depends on multiple factors, including:
A. Reactor design and operation:
   (1) amount of catalyst (too much can “block” photons, amount of contaminant adsorbed to catalyst photons absorbed by “clean” catalyst are wasted, reactor geometry and catalyst perturbation affects blocking;
   (2) Distance photons travel through liquid: some proportion of photons are absorbed adsorbed by the liquid. More distance=more absorption; and
   (3) Dwell/residence time;
B. Catalyst Properties and characteristics:
   (1) Surface: surface adjustment can enhance e−,h+ emission;
   (2) Geometry: an increased surface to volume ratio increases ratio of e−,h+ emission to internal recombination; and
   (3) Electrical properties: bandgap.

The present invention is also directed to a method of treating a fluid containing contaminant, the method comprising:
supplying the fluid to a first contaminant concentration sub-stage;
outputting from a first-contaminant-concentration-sub-stage first outlet a first-stage first portion comprising a first-stage first concentration of the first contaminant;
outputting from a first-contaminant-concentration-sub-stage second outlet a first-stage second portion comprising a first-stage second concentration of the first contaminant, the first-stage first concentration of the first contaminant greater than the first-stage second concentration of the first contaminant;
supplying the first-stage first portion to a first PCD vessel of a PCD sub-stage, the first PCD sub-stage comprising the first PCD vessel and a first PCD photocatalyst, the first PCD photocatalyst is in the first PCD vessel; and
directing electromagnetic radiation at the first PCD vessel.

The present invention is also directed to a system for treating contaminant in a fluid, the system comprising:
a first contaminant concentration sub-stage and a first PCD sub-stage;
the first contaminant concentration sub-stage comprising a first-contaminant-concentration-sub-stage first inlet, a first-contaminant-concentration-sub-stage first outlet and a first-contaminant-concentration-sub-stage second outlet;
the first contaminant concentration sub-stage is configured to:
   receive through the first-contaminant-concentration-sub-stage first inlet a fluid supply, the fluid supply comprising an inlet concentration of a first contaminant;
   output from the first-contaminant-concentration-sub-stage first outlet a first-stage first portion comprising a first-stage first concentration of the first contaminant;
   output from the first-contaminant-concentration-sub-stage second outlet a first-stage second portion comprising a first-stage second concentration of the first contaminant, the first-stage first concentration of the first contaminant greater than the first-stage second concentration of the first contaminant;
the first PCD sub-stage comprises a first PCD vessel and a first PCD photocatalyst, the first PCD photocatalyst in the first PCD vessel;
the first PCD vessel comprises a first-PCD-vessel first inlet;
the first PCD sub-stage comprises a first-PCD-sub-stage first outlet;
the first-contaminant-concentration-sub-stage first outlet is fluid-flow connected to the first-PCD-vessel first inlet.

The present invention is also directed to systems as described above, in which one or more PCD systems further comprise one or more lamps configured to emit light that photocatalyzes the PCD photocatalyst material. Such lamps, especially UV lamps, can have a wide wavelength spectrum.

The present invention is directed to methods in which any of the systems described herein, including each of the systems shown in any of FIGS. 3, 5, 7, 9, 11, 13, 15, 17, 19, 21 and 23-26 (including systems with one or more stages as shown in any of FIGS. 3, 9, 11, 15, 17 and 21, as well as systems including combinations of two or more types of stages, i.e., systems that include one or more stage according to each of two or more of the types of stages as shown in FIGS. 3, 9, 11, 15, 17 and 21.

The systems and methods described herein can be used to treat any contaminant in any fluid, e.g., any compounds, atoms or isotopes. For example, with response adjusters as described herein, using foam fractionation, and/or with fractionation as described herein (e.g. solid/liquid/gas/gel), atoms and isotopes can be separated into a fraction. In some aspects, the systems and methods described herein are used to treat any type of PFAS in water. A large number of PFAS have been identified and are known by those of skill in the art, and the systems and methods of the present invention can be applied to treat any such compounds. Representative examples of PFAS include perfluorooctanoic acid (PFOA), perfluorobutane sulfonate (PFBS) and perfluorooctane sulfonate (PFOS).

In any of the systems and methods described herein that comprise contamination concentration, one of more stages of contamination concentration can be by fractionation.

In any of the systems and methods described herein that comprise contamination concentration, one of more stages of contamination concentration can be by foam fractionation. Foam fractionation can be carried out in any suitable foam fractionator, e.g., a fractionator that comprises a vessel with an inlet and an outlet, and an air/water interface-generator, such as a bubble maker. In embodiments that comprise a foam fractionator, the foam fractionator preferably is configured to generate a large air/water interface, e.g., by injecting large numbers of bubbles into the fractionation column. In embodiments that comprise a bubble maker, any suitable bubble maker can be employed. One representative example of a suitable bubble maker is a disc into which air is blown, the disc having holes of a size (or sizes) suitable for generating bubbles. Another representative example of a suitable bubble maker is a device that draws liquid into a tube with a pump that draws air, e.g., a needle wheel pump that chops air bubbles into smaller bubbles, which are then fed into the bottom of the PCD vessel. Any suitable gas can be used to make the bubbles, e.g., air, noble gas (such as argon), or nitrogen.

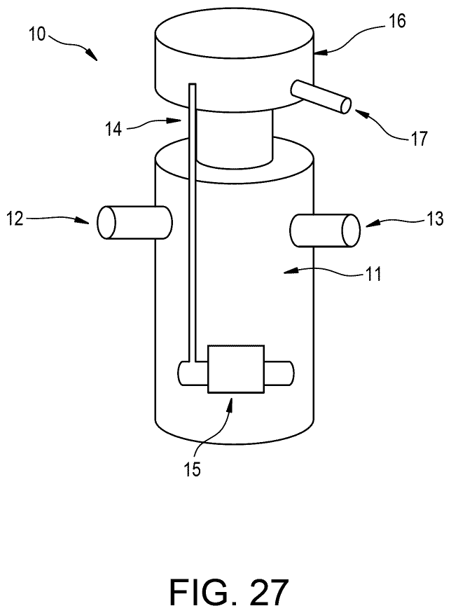

In any of the systems and methods described herein, the PCD system (or any of plural PCD systems) can be any suitable PCD system, e.g., a system comprising a PCD vessel (which may be in the form of a clear container, e.g., a container made of quartz), PCD photocatalyst material, any suitable stirring mechanism (suitable for keeping the PCD photocatalyst material from settling to the bottom of the PCD vessel, but not reaching the top of the fluid in the vessel), and lamps for emitting light that hits the PCD photocatalyst material. A reflector (or plural reflectors) can be positioned around the lamps to increase absorption of photons by the PCD photocatalyst material. For embodiments with continuous flow through the PCD vessel, an inlet and outlet similar to those for the foam fractionation column depicted in FIG. 27 can be included. PCD photocatalyst material can be retained within the PCD vessel by a PCD photocatalyst retainer, e.g., a sieve-like material within which the PCD photocatalyst is positioned. In any such PCD system, the photocatalyst material can be any material that is capable of catalyzing generation of photo-induced electron and hole pairs, and/or that produces one or more reactive oxygen species. Representative examples of photocatalyst material that can be used in accordance with the present invention include TiO2, h-BN (hexagonal boron nitride), epitaxial hexagonal boron nitride/boron nitride nanotube (“epitaxial h-BN/BNNT”) as described in U.S. Pat. No. 11,332,369, the entirety of which—in particular the disclosure of epitaxial h-BN/BNNT and how it is made—is incorporated herein by reference, BiPO₄, Bi₃O(OH)(POR₄)₂, β-Ga₂O₃, SiC and In₂O₃. Respective suitable and preferred wavelength ranges for light to photocatalyze the photocatalyst material for different types of photocatalyst are shown below:
TiO₂: suitable range (180-430 nm); preferred (250-380 nm)
h-BN: suitable range (180-400 nm); preferred (200-250 nm)
epitaxial h-BN/BNNT: suitable range (180-400 nm); preferred (200-250 nm)
BiPO₄: suitable range (180-290 nm); preferred (200-230 nm)
Bi₃O(OH)(PO₄)₂: suitable range (180-315 nm); preferred (200-275 nm)
β-Ga₂O₃: suitable range (190-300 nm); preferred (200-230 nm)
SiC: suitable range (200-350 nm); preferred (225-275 nm)
In₂O₃: suitable range (200-400 nm); preferred (250-350 nm)

In any of the systems and methods described herein in which one or more response adjusters are employed, any material that, when added to a mixture, adjusts the properties of a single, multiple, or all components to adjust the responsiveness of a single, multiple, or all components can be employed, e.g., to increase the responsiveness of one or more contaminants. Representative examples of materials that can be employed as response adjusters include FeCl, Na (NaCl), Ca (CaCl₂), Mg (MgCl₂), benzalkonium chloride, benzethonium chloride, benzododecinium bromide, benzododecinium chloride, benzoxonium bromide, cetalkonium chloride, cetrimide, cetrimonium bromide, cetrimonium chloride, cetylpyridinium chloride, and cetyltrimethylammonium bromide (CTAB).

In any system described herein (including any embodiment of a system as described herein), one or more fluid-handling components or systems can be provided at any suitable location(s) in the systems,” and any method described herein (including any embodiment of a method as described herein) can comprise any activity that would occur upon fluid being treated by any of the systems described herein that comprises one or more such fluid-handling components or systems. Representative examples of fluid-handling components and systems include filters, holding tanks, pumps, backflow preventers, valves, fittings, meters, couplings, meter stops, pressure regulators, and manifolds.

The systems and methods described herein can be used to treat volumes of fluid (e.g., contaminated fluid) of any magnitude, and flow rates of streams and capacities of columns and vessels can be of any suitable amounts. Representative flow rates and capacities for systems and methods depicted in FIGS. 3, 5 and 7 are as follows:

### FIGS. 3, 5 and 7:

water supply flow rate=280 liters per minute (lpm)
fractionation column 1 volume=1120 liters
fractionation column 2 volume=280 liters
fractionation column 3 volume=112 liters
fractionation column 4 volume=45 liters
fractionation column 5 volume=18 liters
fractionation column 6 volume=7 liters
PCD vessel volume=12 liters
   For such flow rates and capacities, suitable fractions and dwell time are:
fractionation column 1
   dwell time=4 minutes
   foam fraction=0.25 (70 lpm)
   base fraction=0.75 (210 lpm)
fractionation column 2
   dwell time=4 minutes
   foam fraction=0.1 (7 lpm).
   base fraction=0.9 (63 lpm)
fractionation column 3
   dwell time=4 minutes
   foam fraction=0.1 (0.7 lpm)
   base fraction=0.9 (6.3 lpm)
fractionation column 4
   dwell time=4 minutes
   foam fraction=0.1 (0.07 lpm)
   base fraction=0.9 (0.63 lpm)
fractionation column 5
   dwell time=4 minutes
   foam fraction=0.1 (0.007 lpm)
   base fraction=0.9 (0.063 lpm)
fractionation column 6
   dwell time=4 minutes
   foam fraction=0.1 (0.0007 lpm)
   base fraction=0.9 (0.0063 lpm)
PCD vessel
   dwell time=17 minutes

### FIG. 9:

water supply flow rate=373 liters per minute
fractionation column 1 volume=1493.33 liters
fractionation column 2 volume=414.81 liters
fractionation column 3 volume=46.09 liters
fractionation column 4 volume=5.12 liters
fractionation column 5 volume=0.57 liters
fractionation column 6 volume=0.057 liters

For such flow rates and capacities, suitable fractions and dwell time are:
fractionation column 1
   dwell time=4 minutes
   foam fraction=0.25 (98.33 lpm)
fractionation column 2
   dwell time=4 minutes
   foam fraction=0.1 (10.37 lpm)
fractionation column 3
   dwell time=4 minutes
   foam fraction=0.1 (1.15 lpm)
fractionation column 4
   dwell time=4 minutes
   foam fraction=0.1 (0.13 lpm)
fractionation column 5
   dwell time=4 minutes
   foam fraction=0.1 (0.014 lpm)
fractionation column 6
   dwell time=4 minutes
   foam fraction=0.1 (0.0014 lpm)

### FIG. 11:

water supply flow rate=280 liters per minute
fractionation column 1 volume=1493.33 liters
fractionation column 2 volume=373.34 liters
fractionation column 3 volume=37.34 liters
fractionation column 4 volume=3.74 liters
fractionation column 5 volume=0.38 liters
fractionation column 6 volume=0.038 liters

For such flow rates and capacities, suitable fractions and dwell time are:
fractionation column 1
   dwell time=4 minutes
   foam fraction=0.25 (93.33 lpm)
fractionation column 2
   dwell time=4 minutes
   foam fraction=0.1 (9.33 lpm)
fractionation column 3
   dwell time=4 minutes
   foam fraction=0.1 (0.93 lpm)
fractionation column 4
   dwell time=4 minutes
   foam fraction=0.1 (0.09 lpm)
fractionation column 5
   dwell time=4 minutes
   foam fraction=0.1 (0.01 lpm)
fractionation column 6
   dwell time=4 minutes
   foam fraction=0.1 (0.001 lpm)

### FIG. 15:

water supply flow rate=280 liters per minute
fractionation column 1 volume=1493.33 liters
fractionation column 2 volume=414.82 liters
fractionation column 3 volume=46.09 liters
fractionation column 4 volume=5.12 liters
fractionation column 5 volume=0.57 liters
fractionation column 6 volume=0.06 liters

For such flow rates and capacities, suitable fractions and dwell time are:
fractionation column 1
   dwell time=4 minutes
   foam fraction=0.25 (93.33 lpm)
fractionation column 2
   dwell time=4 minutes
   foam fraction=0.1 (10.37 lpm)
fractionation column 3
   dwell time=4 minutes
   foam fraction=0.1 (1.15 lpm)
fractionation column 4
   dwell time=4 minutes
   foam fraction=0.1 (0.13 lpm)
fractionation column 5
   dwell time=4 minutes
   foam fraction=0.1 (0.014 lpm)
fractionation column 6
   dwell time=4 minutes
   foam fraction=0.1 (0.002 lpm)

### FIG. 17:

water supply flow rate=280 liters per minute
fractionation column 1 volume=1244.44 liters
fractionation column 2 volume=124.44 liters
fractionation column 3 volume=12.44 liters
fractionation column 4 volume=1.24 liters
fractionation column 5 volume=0.12 liters
fractionation column 6 volume=0.01 liters

For such flow rates and capacities, suitable fractions and dwell time are:
fractionation column 1
   dwell time=4 minutes
   foam fraction=0.25 (31.11 lpm)
fractionation column 2
   dwell time=4 minutes
   foam fraction=0.1 (3.11 lpm)
fractionation column 3
   dwell time=4 minutes
   foam fraction=0.1 (0.3 lpm)
fractionation column 4
   dwell time=4 minutes
   foam fraction=0.1 (0.03 lpm)
fractionation column 5:
   dwell time=4 minutes
   foam fraction=0.1 (0.003 lpm)
fractionation column 6
   dwell time=4 minutes
   foam fraction=0.1 (0.0003 lpm)

In any of the systems and methods described herein an inlet (or likewise an outlet) can be any structure though which fluid can pass, e.g., an opening of any size or shape. It is conceivable that one structure could function as both an inlet and an outlet. In the drawing Figs., inlets are represented by the part of a component (schematically shown) to which an arrowhead points, and outlets are represented by the part of a component from which the tail of an arrow emanates.

In any of the systems and methods described herein, the ratio of the amount of fluid supplied to a PCD vessel in a stage divided by the amount of fluid supplied to a contamination concentration sub-stage of that stage can be any suitable value, e.g., 10⁻⁵ to 10⁻⁹, e.g., 10⁻⁶ to 10⁻⁸, e.g., about 1:500,000 to 1:2 million, e.g., for an input of about 1 million gallons per day, about one gallon passes through the PCD vessel per day.

In any of the systems and methods described herein, the ratio of the concentration of contaminant in fluid supplied to a PCD vessel of a stage divided by the concentration of contaminant in the fluid supplied to the contaminant concentration sub-stage of that stage can be any suitable value, e.g., 10⁵ to 10⁹, e.g., 10⁶ to 10⁸, e.g., about 500,000:1 to 2 million:1, e.g., where fluid supplied to the contaminant concentration stage has a concentration of contaminant of about 1 ppt, the contaminant concentration of the fluid supplied to the PCD vessel is about 1 ppm.

In any of the systems and methods described herein, suitable valves can be provided in any suitable location to control flow. Those of skill in the art are familiar with a wide variety of valves, and any such valves can be employed in the systems and methods in accordance with the present invention.

Various outputs from systems and methods in accordance with the present invention (e.g., PCD outputs, CwD outputs and fractionation column outputs) can be combined or kept separate, e.g., they can be provided for applications for which there are different contamination tolerances (since the different outputs will typically have different contamination concentrations), and/or they can be feed to specific parts of a system (recirculated or sent forward), and/or they might have different contaminants (and/or different concentrations of respective contaminants).

In many instances, where a contaminated supply has a high concentration of contaminants, the volume of the supply is relatively low.

FIG. 27 is a schematic drawing of a representative example of a foam fractionator 10 suitable for use as a fractionator in a system or method in accordance with the present invention. Referring to FIG. 27, the foam fractionator 10 comprises a water column 11, a water inlet 12, a water outlet 13, an air intake 14, a pump 15, a foam collector 16 and a foam drain 17.

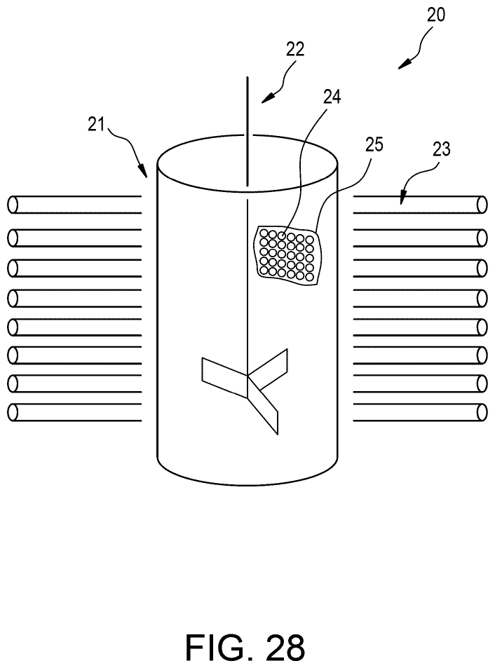

FIG. 28 is a schematic drawing of a representative example of a PCD system 20 suitable for use as a PCD system in accordance with the present invention. Referring to FIG. 28, the PCD system 20 comprises a PCD vessel 21 (in the form of a clear container), a stirring mechanism 22, UV lamps 23 configured to emit UV-C light, PCD photocatalyst material 24 and a PCD photocatalyst material retainer 25 in the form of a sieve material that surrounds the PCD photocatalyst. Only portions of the PCD photocatalyst material and PCD photocatalyst material retainer 25 are shown in FIG. 28.

Detailed descriptions of embodiments that correspond to the present invention (and/or aspects of the present invention), and detailed descriptions of features that are provided in some embodiments in accordance with the present invention, are provided herein, in many instances with reference to the accompanying drawings, in which representative embodiments in accordance with the present invention are shown. Embodiments in accordance with the present invention are described herein in detail in order to provide exact features of representative embodiments that are within the overall scope of the present invention. The present invention is not limited to such detail. That is, every statement about an embodiment described herein is to be interpreted as being prefaced with “In this embodiment, . . . ”

In accordance with a third aspect of the present invention, there is provided a system for administering PCD to a fluid, the system comprising:
a PCD vessel;
a PCD photocatalyst, the PCD photocatalyst is in the PCD vessel; and
a lamp configured to emit photons of at least one wavelength that, upon being absorbed by the PCD photocatalyst, causes the PCD photocatalyst to generate photo-induced electron and hole pairs,
the PCD photocatalyst comprising epitaxial hexagonal boron nitride/boron nitride nanotube.

In some embodiments in accordance with the third aspect of the present invention, the lamp emits photons of wavelength in the range of from 180 nm to 400 nm.

In accordance with a fourth aspect of the present invention, there is provided a method for administering PCD to a fluid, the method comprising:
directing electromagnetic radiation at a PCD vessel, the PCD vessel containing the fluid and a PCD photocatalyst, causing the PCD photocatalyst to absorb photons and generate photo-induced electron and hole pairs,
the PCD photocatalyst comprising epitaxial hexagonal boron nitride/boron nitride nanotube.

In some embodiments in accordance with the fourth aspect of the present invention, the electromagnetic radiation is of wavelength in the range of from 180 nm to 400 nm.

In accordance with a fourth aspect of the present invention, there is provided a method for administering PCD to a fluid, the method comprising:
continuously supplying fluid to a PCD vessel for at least a first period of time, the PCD vessel containing a PCD photocatalyst;
directing electromagnetic radiation at the PCD vessel, causing the PCD photocatalyst to absorb photons and generate photo-induced electron and hole pairs; and
continuously removing fluid from the PCD vessel during the first period of time.

In some embodiments in accordance with the fifth aspect of the present invention, the PCD photocatalyst comprising epitaxial hexagonal boron nitride/boron nitride nanotube, and in some of those embodiments, the electromagnetic radiation is of wavelength in the range of from 180 nm to 400 nm.

Any two or more structural parts of the systems described herein can be integrated. Any structural part of the systems described herein can be provided in two or more parts (which can be held together, if necessary). Similarly, any two or more functions can be conducted simultaneously, and/or any function can be conducted in a series of steps.

Furthermore, while certain embodiments of the present invention have been illustrated with reference to specific combinations of elements and attributes, various other combinations may also be provided without departing from the teachings of the present invention. Thus, the present invention should not be construed as being limited to the particular exemplary embodiments described herein and illustrated in the Figures, but may also encompass combinations of elements and attributes of the various illustrated embodiments.

Based on the information provided in the present disclosure, many alterations and modifications may be made by those having ordinary skill in the art, given the benefit of the present disclosure, without departing from the teaching of the present specification, and/or without departing from the spirit and scope of the present invention.

1. A system for treating contaminant in a fluid, the system comprising:
a first stage, the first stage comprising a first contaminant concentration sub-stage and a first PCD sub-stage;
the first contaminant concentration sub-stage comprising a first-contaminant-concentration-sub-stage first inlet, a first-contaminant-concentration-sub-stage first outlet and a first-contaminant-concentration-sub-stage second outlet;
the first contaminant concentration sub-stage is configured to:
receive through the first-contaminant-concentration-sub-stage first inlet a fluid supply, the fluid supply comprising an inlet concentration of a first contaminant;
output from the first-contaminant-concentration-sub-stage first outlet a first-stage first portion comprising a first-stage first concentration of the first contaminant; and
output from the first-contaminant-concentration-sub-stage second outlet a first-stage second portion comprising a first-stage second concentration of the first contaminant, the first-stage first concentration of the first contaminant greater than the first-stage second concentration of the first contaminant;
the first PCD sub-stage comprises a first PCD vessel and a first PCD photocatalyst, the first PCD photocatalyst in the first PCD vessel;
the first PCD vessel comprises a first-PCD-vessel first inlet;
the first PCD sub-stage comprises a first-PCD-sub-stage first outlet; and
the first-contaminant-concentration-sub-stage first outlet is fluid-flow connected to the first-PCD-vessel first inlet.

2. The system recited in claim 1, wherein the first contaminant concentration sub-stage comprises at least a first fractionation column.

3. The system recited in claim 1, wherein the PCD sub-stage further comprises a first lamp.

4. The system recited in claim 1, wherein:
the first contaminant concentration sub-stage comprises a plurality of fractionation columns, the plurality of fractionation columns comprising a first series of at least two fractionation columns starting with a first fractionation column and ending with a last fractionation column,
each fractionation column in the first series of fractionation columns comprises a contaminant-fraction outlet and a base-fraction outlet,
for each fractionation column in the first series of fractionation columns except for the last fractionation column, the contaminant-fraction outlet is fluid-flow connected to an inlet of a fractionation column that is next in the first series of fractionation columns, and
a contaminant-fraction outlet of the last fractionation column is fluid-flow connected to an inlet of the first PCD vessel.

5. The system recited in claim 4, wherein:
the system further comprises at least a first serial-separation stage, the first serial-separation stage comprising a first series of separation-stage fractionation columns starting with a first separation-stage fractionation column and ending with a last separation-stage fractionation column,
each separation-stage fractionation column in the first series of separation-stage fractionation columns comprises a separation-stage-contaminant-fraction outlet and a separation-stage-base-fraction outlet,
for each separation-stage fractionation column in the first series of separation-stage fractionation columns except for the last separation-stage fractionation column, the base-fraction outlet from that separation-stage fractionation column is fluid-flow connected to a next separation-stage fractionation column in the first series of separation-stage fractionation columns, and
a separation-stage-contaminant-fraction outlet of at least one of the separation-stage fractionation columns is fluid-flow connected to the first-contaminant-concentration-sub-stage first inlet.

6. The system recited in claim 1, wherein:
the system further comprises a second stage, the second stage comprising a second contaminant concentration sub-stage and a second PCD sub-stage, the second contaminant concentration sub-stage comprising a second-stage first inlet,
the second contaminant concentration sub-stage comprises a second-contaminant-concentration-sub-stage first outlet and a second-contaminant-concentration-sub-stage second outlet,
the second contaminant concentration sub-stage is configured to:
receive fluid from the first-PCD-sub-stage first outlet;
output from the second-contaminant-concentration-sub-stage first outlet a second-stage first portion comprising a second-stage first concentration of the first contaminant; and
output from the second-contaminant-concentration-sub-stage second outlet a second-stage second portion comprising a second-stage second concentration of the first contaminant, the second-stage first concentration of the first contaminant greater than the second-stage second concentration of the first contaminant;
the second PCD sub-stage comprises a second PCD vessel and a photocatalyst in the second PCD vessel;
the second PCD vessel comprises a second-PCD-vessel first inlet,
the second-contaminant-concentration-sub-stage first outlet is fluid-flow connected to the second-PCD-vessel first inlet, and
the first-PCD-sub-stage first outlet is fluid flow-connected to the second-stage first inlet.

7. The system recited in claim 6, wherein:
each contaminant concentration sub-stage comprises a series of at least two fractionation columns starting with a first fractionation column and ending with a last fractionation column,
for each series of fractionation columns, each fractionation column in that series of fractionation columns comprises a contaminant-fraction outlet and a base-fraction outlet,
for each series of fractionation columns, for each fractionation column in that series of fractionation columns except for the last fractionation column, the contaminant-fraction outlet is fluid-flow connected to an inlet of a fractionation column that is next in that series of fractionation columns, and
for each series of fractionation columns, a contaminant-fraction outlet of the last fractionation column in that series is fluid-flow connected to an inlet of the PCD vessel in the same stage.

8. The system recited in claim 1, wherein:
the system comprises a series of stages comprising the first stage and at least one additional stage, the series of stages starting with the first stage and ending with a last stage,
each of the at least one additional stage comprises a respective contaminant concentration sub-stage and a PCD sub-stage,
each contaminant concentration sub-stage comprises a respective first inlet, a respective first outlet and a respective second outlet,
each contaminant concentration sub-stage is configured to:
receive fluid through its first inlet;
output from its first outlet a respective first portion comprising a first concentration of the first contaminant; and
output from its second outlet a respective second portion comprising a second concentration of the first contaminant, the respective first concentration of the first contaminant greater than the respective second concentration of the first contaminant;
each PCD sub-stage comprises a respective PCD vessel and a respective photocatalyst in the respective PCD vessel,
each PCD vessel comprises a respective PCD-vessel first inlet, and
for at least one stage in the series of stages, a PCD outlet for that stage is fluid-flow connected to a contaminant-concentration-sub-stage inlet for a stage that is next in the series of stages.

9. The system recited in claim 8, wherein for each stage in the series of stages except for the last stage, a PCD outlet for that stage is fluid-flow connected to a contaminant-concentration-sub-stage inlet for a stage that is next in the series of stages.

10. The system recited in claim 8, wherein:
each contaminant concentration sub-stage comprises a series of at least two fractionation columns starting with a first fractionation column and ending with a last fractionation column,
for each series of fractionation columns, each fractionation column in that series of fractionation columns comprises a contaminant-fraction outlet and a base-fraction outlet,
for each series of fractionation columns, for each fractionation column in that series of fractionation columns except for the last fractionation column, the contaminant-fraction outlet is fluid-flow connected to an inlet of a fractionation column that is next in that series of fractionation columns, and
for each series of fractionation columns, a contaminant-fraction outlet of the last fractionation column in that series is fluid-flow connected to an inlet of the PCD vessel in the same stage.

11. The system recited in claim 1, wherein:
the system further comprises a second stage, the second stage comprising a second contaminant concentration sub-stage and a second PCD sub-stage,
the second contaminant concentration sub-stage comprises a second-stage first inlet,
the second contaminant concentration sub-stage comprises a second-contaminant-concentration-sub-stage first outlet and a second-contaminant-concentration-sub-stage second outlet,
the second contaminant concentration sub-stage is configured to:
receive fluid from the first-contaminant-concentration-sub-stage second outlet;
output from the second-contaminant-concentration-sub-stage first outlet a second-stage first portion comprising a second-stage first concentration of the first contaminant; and
output from the second-contaminant-concentration-sub-stage second outlet a second-stage second portion comprising a second-stage second concentration of the first contaminant, the second-stage first concentration of the first contaminant greater than the second-stage second concentration of the first contaminant;
the second PCD sub-stage comprises a second PCD vessel and a photocatalyst in the second PCD vessel,
the second PCD vessel comprises a second-PCD-vessel first inlet,
the second-contaminant-concentration-sub-stage first outlet is fluid-flow connected to the second-PCD-vessel first inlet, and
the first-contaminant-concentration-sub-stage second outlet is fluid-flow connected to the second contaminant concentration sub-stage.

12. The system recited in claim 11, wherein:
each contaminant concentration sub-stage comprises a series of at least two fractionation columns starting with a first fractionation column and ending with a last fractionation column,
for each series of fractionation columns, each fractionation column in that series of fractionation columns comprises a contaminant-fraction outlet and a base-fraction outlet,
for each series of fractionation columns, for each fractionation column in that series of fractionation columns except for the last fractionation column, the contaminant-fraction outlet is fluid-flow connected to an inlet of a fractionation column that is next in that series of fractionation columns, and
for each series of fractionation columns, a contaminant-fraction outlet of the last fractionation column in that series is fluid-flow connected to an inlet of the PCD vessel in the same stage.

13. The system recited in claim 11, wherein the first-PCD-sub-stage first outlet is fluid flow-connected to the first-contaminant-concentration-sub-stage first inlet.

14. The system recited in claim 1, wherein:
the system comprises a series of stages comprising the first stage and at least one additional stage, the series of stages starting with the first stage and ending with a last stage,
each of the at least one additional stage comprises a respective contaminant concentration sub-stage and a PCD sub-stage,
each contaminant concentration sub-stage comprises a respective first inlet, a respective first outlet and a respective second outlet,
each contaminant concentration sub-stage is configured to:
receive fluid through its first inlet;
output from its first outlet a respective first portion comprising a first concentration of the first contaminant; and
output from its second outlet a respective second portion comprising a second concentration of the first contaminant, the respective first concentration of the first contaminant greater than the respective second concentration of the first contaminant;
each PCD sub-stage comprises a respective PCD vessel and a respective photocatalyst in the respective PCD vessel,
each PCD vessel comprises a respective PCD-vessel first inlet, and
for at least one stage in the series of stages, a contaminant-concentration-sub-stage second outlet is fluid-flow connected to a contaminant-concentration-sub-stage inlet for a stage that is next in the series of stages.

15. The system recited in claim 14, wherein for each stage in the series of stages except for the last stage, a contaminant-concentration-sub-stage second outlet is fluid-flow connected to a contaminant-concentration-sub-stage inlet for a stage that is next in the series of stages.

16. The system recited in claim 14, wherein:
each contaminant concentration sub-stage comprises a series of at least two fractionation columns starting with a first fractionation column and ending with a last fractionation column,
for each series of fractionation columns, each fractionation column in that series of fractionation columns comprises a contaminant-fraction outlet and a base-fraction outlet,
for each series of fractionation columns, for each fractionation column in that series of fractionation columns except for the last fractionation column, the contaminant-fraction outlet is fluid-flow connected to an inlet of a fractionation column that is next in that series of fractionation columns, and
for each series of fractionation columns, a contaminant-fraction outlet of the last fractionation column in that series is fluid-flow connected to an inlet of the PCD vessel in the same stage.

17. The system recited in claim 14, wherein for at least one of the stages in the series of stages, a PCD outlet is fluid flow-connected to a contaminant-concentration-sub-stage inlet of that stage.

18. The system recited in claim 1, wherein:
the system further comprises a second stage, the second stage comprising a second contaminant concentration sub-stage and a second PCD sub-stage,
the second contaminant concentration sub-stage comprising a second-stage first inlet,
the second contaminant concentration sub-stage comprises a second-contaminant-concentration-sub-stage first outlet and a second-contaminant-concentration-sub-stage second outlet,
the second contaminant concentration sub-stage is configured to:
receive fluid from the first-PCD-sub-stage first outlet;
receive fluid from the first-contaminant-concentration-sub-stage second outlet;
output from the second-contaminant-concentration-sub-stage first outlet a second-stage first portion comprising a second-stage first concentration of the first contaminant; and
output from the second-contaminant-concentration-sub-stage second outlet a second-stage second portion comprising a second-stage second concentration of the first contaminant, the second-stage first concentration of the first contaminant greater than the second-stage second concentration of the first contaminant;
the second PCD sub-stage comprises a second PCD vessel and a photocatalyst in the second PCD vessel,
the second PCD vessel comprises a second-PCD-vessel first inlet,
the second-contaminant-concentration-sub-stage first outlet is fluid-flow connected to the second-PCD-vessel first inlet,
the first-PCD-sub-stage first outlet is fluid flow-connected to the second contaminant concentration sub-stage, and
the first-contaminant-concentration-sub-stage second outlet is fluid-flow connected to the second contaminant concentration sub-stage.

19. The system recited in claim 18, wherein:
each contaminant concentration sub-stage comprises a series of at least two fractionation columns starting with a first fractionation column and ending with a last fractionation column,
for each series of fractionation columns, each fractionation column in that series of fractionation columns comprises a contaminant-fraction outlet and a base-fraction outlet,
for each series of fractionation columns, for each fractionation column in that series of fractionation columns except for the last fractionation column, the contaminant-fraction outlet is fluid-flow connected to an inlet of a fractionation column that is next in that series of fractionation columns, and
for each series of fractionation columns, a contaminant-fraction outlet of the last fractionation column in that series is fluid-flow connected to an inlet of the PCD vessel in the same stage.

20. The system recited in claim 1, wherein:
the system comprises a series of stages comprising the first stage and at least one additional stage, the series of stages starting with the first stage and ending with a last stage,
each of the at least one additional stage comprises a respective contaminant concentration sub-stage and a PCD sub-stage,
each contaminant concentration sub-stage comprises a respective first inlet, a respective first outlet and a respective second outlet,
each contaminant concentration sub-stage is configured to:
receive fluid through its first inlet;
output from its first outlet a respective first portion comprising a first concentration of the first contaminant; and
output from its second outlet a respective second portion comprising a second concentration of the first contaminant, the respective first concentration of the first contaminant greater than the respective second concentration of the first contaminant;
each PCD sub-stage comprises a respective PCD vessel and a respective photocatalyst in the respective PCD vessel,
each PCD vessel comprises a respective PCD-vessel first inlet,
for at least one stage in the series of stages, a PCD outlet for that stage is fluid-flow connected to a contaminant-concentration-sub-stage inlet for a stage that is next in the series of stages, and
for at least one stage in the series of stages, a contaminant-concentration-sub-stage second outlet is fluid-flow connected to a contaminant-concentration-sub-stage inlet for a stage that is next in the series of stages.

21. The system recited in claim 20, wherein:
for each stage in the series of stages except for the last stage, a PCD outlet for that stage is fluid-flow connected to a contaminant-concentration-sub-stage inlet for a stage that is next in the series of stages, and
for each stage in the series of stages except for the last stage, a contaminant-concentration-sub-stage second outlet is fluid-flow connected to a contaminant-concentration-sub-stage inlet for a stage that is next in the series of stages.

22. The system recited in claim 20, wherein:
each contaminant concentration sub-stage comprises a series of at least two fractionation columns starting with a first fractionation column and ending with a last fractionation column,
for each series of fractionation columns, each fractionation column in that series of fractionation columns comprises a contaminant-fraction outlet and a base-fraction outlet,
for each series of fractionation columns, for each fractionation column in that series of fractionation columns except for the last fractionation column, the contaminant-fraction outlet is fluid-flow connected to an inlet of a fractionation column that is next in that series of fractionation columns, and
for each series of fractionation columns, a contaminant-fraction outlet of the last fractionation column in that series is fluid-flow connected to an inlet of the PCD vessel in the same stage.

23. The system recited in claim 1, wherein the first-PCD-sub-stage first outlet is fluid flow-connected to the first-contaminant-concentration-sub-stage first inlet.

24. The system recited in claim 1, wherein:
the system comprises a series of stages comprising the first stage and at least one additional stage, the series of stages starting with the first stage and ending with a last stage,
each of the at least one additional stage comprises a respective contaminant concentration sub-stage and a PCD sub-stage,
each contaminant concentration sub-stage comprises a respective first inlet, a respective first outlet and a respective second outlet,
each contaminant concentration sub-stage is configured to:
receive fluid through its first inlet;
output from its first outlet a respective first portion comprising a first concentration of the first contaminant; and
output from its second outlet a respective second portion comprising a second concentration of the first contaminant, the respective first concentration of the first contaminant greater than the respective second concentration of the first contaminant;
each PCD sub-stage comprises a respective PCD vessel and a respective photocatalyst in the respective PCD vessel,
each PCD vessel comprises a respective PCD-vessel first inlet,
each PCD sub-stage has a respective PCD-sub-stage outlet, and
for at least one stage in the series of stages, the respective PCD-sub-stage outlet is fluid-flow connected to a contaminant-concentration-sub-stage inlet of the contaminant concentration sub-stage for that stage.

25. The system recited in claim 24, wherein for each stage in the series of stages, the respective PCD-sub-stage outlet is fluid-flow connected to a contaminant-concentration-sub-stage inlet of the contaminant concentration sub-stage for that stage.

26. The system recited in claim 24, wherein:
each contaminant concentration sub-stage comprises a series of at least two fractionation columns starting with a first fractionation column and ending with a last fractionation column,
for each series of fractionation columns, each fractionation column in that series of fractionation columns comprises a contaminant-fraction outlet and a base-fraction outlet,
for each series of fractionation columns, for each fractionation column in that series of fractionation columns except for the last fractionation column, the contaminant-fraction outlet is fluid-flow connected to an inlet of a fractionation column that is next in that series of fractionation columns, and
for each series of fractionation columns, a contaminant-fraction outlet of the last fractionation column in that series is fluid-flow connected to an inlet of the PCD vessel in the same stage.

27. The system recited in claim 1, wherein:
the first contaminant concentration sub-stage comprises a plurality of fractionation columns, the plurality of fractionation columns comprising a first series of fractionation columns starting with a first fractionation column and ending with a last fractionation column,
each fractionation column in the first series of fractionation columns comprises a contaminant-fraction outlet and a base-fraction outlet,
for each fractionation column in the first series of fractionation columns except for the last fractionation column, the contaminant-fraction outlet is fluid-flow connected to an inlet of a fractionation column that is next in the first series of fractionation columns,
a contaminant-fraction outlet of the last fractionation column is fluid-flow connected to an inlet of the first PCD vessel, and
for at least one of the fractionation columns in the first series of fractionation columns, the base-fraction outlet is fluid-flow connected to an inlet of a fractionation column that is prior in the first series of fractionation columns.

28. The system recited in claim 27, wherein for each of the fractionation columns in the first series of fractionation columns except for the first fractionation column, the base-fraction outlet is fluid-flow connected to an inlet of a fractionation column that is prior in the first series of fractionation columns.

29. The system recited in claim 27, wherein:
the system comprises a series of stages comprising the first stage and at least one additional stage,
each of the at least one additional stage comprises a respective contaminant concentration sub-stage and a PCD sub-stage,
each contaminant concentration sub-stage comprises a respective first inlet, a respective first outlet and a respective second outlet,
each contaminant concentration sub-stage is configured to:
receive fluid through its first inlet;
output from its first outlet a respective first portion comprising a first concentration of the first contaminant; and
output from its second outlet a respective second portion comprising a second concentration of the first contaminant, the respective first concentration of the first contaminant greater than the respective second concentration of the first contaminant;
each PCD sub-stage comprises a respective PCD vessel and a respective photocatalyst in the respective PCD vessel, and
each PCD vessel comprises a respective PCD-vessel first inlet and a respective PCD-vessel first outlet.

30. The system recited in claim 29, wherein:
each contaminant concentration sub-stage comprises a respective series of fractionation columns starting with a respective first fractionation column and ending with a respective last fractionation column,
each fractionation column in each respective series of fractionation columns comprises a respective contaminant-fraction outlet and a respective base-fraction outlet,
in each respective series of fractionation columns, for each fractionation column except for the last fractionation column, the contaminant-fraction outlet is fluid-flow connected to an inlet of a fractionation column that is next in the respective series of fractionation columns,
for each series of fractionation columns, a contaminant-fraction outlet of the last fractionation column is fluid-flow connected to an inlet of a PCD vessel, and
for at least one of the fractionation columns in each series of fractionation columns, the base-fraction outlet is fluid-flow connected to an inlet of a fractionation column that is prior in that series of fractionation columns.

31. The system recited in claim 30, wherein:
for each fractionation column in each series of fractionation columns, the base-fraction outlet is fluid-flow connected to an inlet of a fractionation column that is prior in that series of fractionation columns.

32. The system recited in claim 1, wherein:
the first contaminant concentration sub-stage comprises a plurality of fractionation columns, the plurality of fractionation columns comprising a first series of fractionation columns starting with a first fractionation column and ending with a last fractionation column,
each fractionation column in the first series of fractionation columns comprises a contaminant-fraction outlet and a base-fraction outlet,
for each fractionation column in the first series of fractionation columns except for the last fractionation column, the contaminant-fraction outlet is fluid-flow connected to an inlet of a fractionation column that is next in the first series of fractionation columns,
a contaminant-fraction outlet of the last fractionation column is fluid-flow connected to an inlet of the first PCD vessel, and
for at least one of the fractionation columns in the first series of fractionation columns, the base-fraction outlet is fluid-flow connected to an inlet of the first fractionation column.

33. The system recited in claim 32, wherein for each of the fractionation columns in the first series of fractionation columns except for the first fractionation column, the base-fraction outlet is fluid-flow connected to an inlet of the first fractionation column.

34. The system recited in claim 32, wherein:
the system comprises a series of stages comprising the first stage and at least one additional stage,
each of the at least one additional stage comprises a respective contaminant concentration sub-stage and a PCD sub-stage,
each contaminant concentration sub-stage comprises a respective first inlet, a respective first outlet and a respective second outlet,
each contaminant concentration sub-stage is configured to:
receive fluid through its first inlet;
output from its first outlet a respective first portion comprising a first concentration of the first contaminant; and
output from its second outlet a respective second portion comprising a second concentration of the first contaminant, the respective first concentration of the first contaminant greater than the respective second concentration of the first contaminant;
each PCD sub-stage comprises a respective PCD vessel and a respective photocatalyst in the respective PCD vessel, and
each PCD vessel comprises a respective PCD-vessel first inlet.

35. The system recited in claim 34, wherein:
each contaminant concentration sub-stage comprises a respective series of fractionation columns starting with a respective first fractionation column and ending with a respective last fractionation column,
each fractionation column in each series of fractionation columns comprises a respective contaminant-fraction outlet and a respective base-fraction outlet,
in each series of fractionation columns, for each fractionation column except for the last fractionation column, the contaminant-fraction outlet is fluid-flow connected to an inlet of a fractionation column that is next in the series of fractionation columns,
for each series of fractionation columns, a contaminant-fraction outlet of the last fractionation column is fluid-flow connected to an inlet of a PCD vessel, and
in each series of fractionation columns, for each of the fractionation columns except for the first fractionation column, the base-fraction outlet is fluid-flow connected to an inlet of the first fractionation column.

36. The system recited in claim 1, wherein:
the first contaminant concentration sub-stage comprises a plurality of fractionation columns, the plurality of fractionation columns comprising a first series of fractionation columns starting with a first fractionation column and ending with a last fractionation column,
each fractionation column in the first series of fractionation columns comprises a contaminant-fraction outlet and a base-fraction outlet,
for each fractionation column in the first series of fractionation columns except for the last fractionation column, the contaminant-fraction outlet is fluid-flow connected to an inlet of a fractionation column that is next in the first series of fractionation columns,
a contaminant-fraction outlet of the last fractionation column is fluid-flow connected to an inlet of the first PCD vessel, and
a PCD outlet of the first PCD sub-stage is fluid-flow connected to an inlet of a prior fractionation column in the first series of fractionation columns.

37. The system recited in claim 36, wherein for at least one of the fractionation columns in the first series of fractionation columns, the base-fraction outlet is fluid-flow connected to an inlet of a fractionation column that is prior in the first series of fractionation columns.

38. The system recited in claim 36, wherein for each of the fractionation columns in the first series of fractionation columns except for the first fractionation column, the base-fraction outlet is fluid-flow connected to an inlet of a fractionation column that is prior in the first series of fractionation columns.

39. The system recited in claim 36, wherein:
the system comprises a series of stages comprising the first stage and at least one additional stage,
each of the at least one additional stage comprises a respective contaminant concentration sub-stage and a PCD sub-stage,
each contaminant concentration sub-stage comprises a respective first inlet, a respective first outlet and a respective second outlet,
each contaminant concentration sub-stage is configured to:
receive fluid through its first inlet;
output from its first outlet a respective first portion comprising a first concentration of the first contaminant; and
output from its second outlet a respective second portion comprising a second concentration of the first contaminant, the respective first concentration of the first contaminant greater than the respective second concentration of the first contaminant;
each PCD sub-stage comprises a respective PCD vessel and a respective photocatalyst in the respective PCD vessel, and
each PCD vessel comprises a respective PCD-vessel first inlet.

40. The system recited in claim 39, wherein:
for each of the stages, a PCD outlet of a PCD sub-stage of that stage is fluid-flow connected to an inlet of a prior fractionation column in the first series of fractionation columns.

41. The system recited in claim 40, wherein:
each contaminant concentration sub-stage comprises a respective series of fractionation columns starting with a respective first fractionation column and ending with a respective last fractionation column,
each fractionation column in each respective series of fractionation columns comprises a respective contaminant-fraction outlet and a respective base-fraction outlet,
in each series of fractionation columns, for each fractionation column except for the last fractionation column, the contaminant-fraction outlet is fluid-flow connected to an inlet of a fractionation column that is next in the series of fractionation columns,
for each series of fractionation columns, a contaminant-fraction outlet of the last fractionation column is fluid-flow connected to an inlet of a PCD vessel, and
for at least one of the fractionation columns in the first series of fractionation columns, the base-fraction outlet is fluid-flow connected to an inlet of a fractionation column that is prior in the first series of fractionation columns.

42. The system recited in claim 41, wherein for each of the fractionation columns in the first series of fractionation columns except for the first fractionation column, the base-fraction outlet is fluid-flow connected to an inlet of a fractionation column that is prior in the first series of fractionation columns.

43. The system recited in claim 1, wherein:
the first contaminant concentration sub-stage comprises a plurality of fractionation columns, the plurality of fractionation columns comprising a first series of fractionation columns starting with a first fractionation column and ending with a last fractionation column,
each fractionation column in the first series of fractionation columns comprises a contaminant-fraction outlet and a base-fraction outlet,
for each fractionation column in the first series of fractionation columns except for the last fractionation column, the contaminant-fraction outlet is fluid-flow connected to an inlet of a fractionation column that is next in the first series of fractionation columns,
a contaminant-fraction outlet of the last fractionation column is fluid-flow connected to an inlet of the first PCD vessel, and
a PCD outlet of the PCD sub-stage is fluid-flow connected to an inlet of the first fractionation column.

44. The system recited in claim 43, wherein:
the system comprises a series of stages comprising the first stage and at least one additional stage,
each of the at least one additional stage comprises a respective contaminant concentration sub-stage and a PCD sub-stage,
each contaminant concentration sub-stage comprises a respective first inlet, a respective first outlet and a respective second outlet,
each contaminant concentration sub-stage is configured to:
receive fluid through its first inlet;
output from its first outlet a respective first portion comprising a first concentration of the first contaminant; and
output from its second outlet a respective second portion comprising a second concentration of the first contaminant, the respective first concentration of the first contaminant greater than the respective second concentration of the first contaminant;
each PCD sub-stage comprises a respective PCD vessel and a respective photocatalyst in the respective PCD vessel, and
each PCD vessel comprises a respective PCD-vessel first inlet.

45. The system recited in claim 44, wherein:
each contaminant concentration sub-stage comprises a respective series of fractionation columns starting with a respective first fractionation column and ending with a respective last fractionation column,
each fractionation column in each respective series of fractionation columns comprises a respective contaminant-fraction outlet and a respective base-fraction outlet,
in each series of fractionation columns, for each fractionation column except for the last fractionation column, the contaminant-fraction outlet is fluid-flow connected to an inlet of a fractionation column that is next in the series of fractionation columns,
for each series of fractionation columns, a contaminant-fraction outlet of the last fractionation column is fluid-flow connected to an inlet of a PCD vessel, and
for each stage in the series of stages, a PCD outlet of a PCD sub-stage of that stage is fluid-flow connected to an inlet of a first fractionation column of that stage.

46. The system recited in claim 45, wherein for at least one of the fractionation columns in each respective series of fractionation columns, the base-fraction outlet is fluid-flow connected to an inlet of a fractionation column that is prior in that series of fractionation columns.

47. The system recited in claim 45, wherein for each of the fractionation columns in at least one of the respective series of fractionation columns, except for the first fractionation column in each series of fractionation columns, the base-fraction outlet is fluid-flow connected to an inlet of a fractionation column that is prior in that series of fractionation columns.

48. The system recited in claim 45, wherein for each of the fractionation columns in each respective series of fractionation columns, except for the first fractionation column in each series of fractionation columns, the base-fraction outlet is fluid-flow connected to an inlet of a fractionation column that is prior in that series of fractionation columns.

49. The system recited in claim 45, wherein for at least one of the fractionation columns in each respective series of fractionation columns, the base-fraction outlet is fluid-flow connected to an inlet of the first fractionation column in that series of fractionation columns.

50. The system recited in claim 45, wherein for each of the fractionation columns in at least one of the respective series of fractionation columns, except for the first fractionation column in each series of fractionation columns, the base-fraction outlet is fluid-flow connected to an inlet of the first fractionation column in that series of fractionation columns.

51. The system recited in claim 45, wherein for each of the fractionation columns in each respective series of fractionation columns, except for the first fractionation column in each series of fractionation columns, the base-fraction outlet is fluid-flow connected to an inlet of the first fractionation column in that series of fractionation columns.

52. The system recited in claim 45, wherein:
for each stage in the series of stages except for the last stage, a base-fraction outlet of at least one fractionation column in that stage is fluid-flow connected to a contaminant concentration sub-stage of a stage that is next in the series of stages.

53. The system recited in claim 45, wherein:
for each stage in the series of stages except for the last stage, a base-fraction outlet of the first fractionation column in that stage is fluid-flow connected to a contaminant concentration sub-stage of a stage that is next in the series of stages.

54. The system recited in claim 44, wherein:
for each stage in the series of stages except for the last stage, a base-fraction outlet of at least one fractionation column in that stage is fluid-flow connected to a contaminant concentration sub-stage of a stage that is next in the series of stages.

55. The system recited in claim 44, wherein:
for each stage in the series of stages except for the last stage, a base-fraction outlet of the first fractionation column in that stage is fluid-flow connected to a contaminant concentration sub-stage of a stage that is next in the series of stages.

56. The system recited in claim 1, wherein:
the first contaminant concentration sub-stage comprises a plurality of fractionation columns, the plurality of fractionation columns comprising a first series of fractionation columns starting with a first fractionation column and ending with a last fractionation column,
each fractionation column in the first series of fractionation columns comprises a contaminant-fraction outlet and a base-fraction outlet,
for each fractionation column in the first series of fractionation columns except for the last fractionation column, the contaminant-fraction outlet is fluid-flow connected to an inlet of a fractionation column that is next in the first series of fractionation columns,
a contaminant-fraction outlet of the last fractionation column is fluid-flow connected to an inlet of the first PCD vessel,
a PCD outlet of the PCD sub-stage is fluid-flow connected to an inlet of the first fractionation column, and
for at least one of the fractionation columns in the first series of fractionation columns, the base-fraction outlet is fluid-flow connected to the first fractionation column.

57. The system recited in claim 56, wherein:
for each of the fractionation columns in the first series of fractionation columns, the base-fraction outlet is fluid-flow connected to the first fractionation column.

58. The system recited in claim 1, wherein:
the system further comprises at least a first serial-separation stage, the first serial-separation stage comprising a first series of separation-stage fractionation columns starting with a first separation-stage fractionation column and ending with a last separation-stage fractionation column,
each separation-stage fractionation column in the first series of separation-stage fractionation columns comprises a separation-stage-contaminant-fraction outlet and a separation-stage-base-fraction outlet,
for each separation-stage fractionation column in the first series of separation-stage fractionation columns except for the last separation-stage fractionation column, the base-fraction outlet from that separation-stage fractionation column is fluid-flow connected to a next separation-stage fractionation column in the first series of separation-stage fractionation columns, and
a separation-stage-contaminant-fraction outlet of at least one of the separation-stage fractionation columns is fluid-flow connected to the first-contaminant-concentration-sub-stage first inlet.

59. The system recited in claim 1, wherein:
the system further comprises at least a first serial-separation stage, the first serial-separation stage comprising a first series of separation-stage fractionation columns starting with a first separation-stage fractionation column and ending with a last separation-stage fractionation column,
each separation-stage fractionation column in the first series of separation-stage fractionation columns comprises at least one separation-stage inlet, a separation-stage-contaminant-fraction outlet and a separation-stage-base-fraction outlet,
for each separation-stage fractionation column in the first series of separation-stage fractionation columns except for the last separation-stage fractionation column, the base-fraction outlet from that separation-stage fractionation column is fluid-flow connected to a next separation-stage fractionation column in the first series of separation-stage fractionation columns,
the system comprises a series of stages comprising the first stage and at least one additional stage,
each of the at least one additional stage comprises a respective contaminant concentration sub-stage and a PCD sub-stage,
each contaminant concentration sub-stage comprises at least one contamination concentration sub-stage inlet, a respective first outlet and a respective second outlet,
each contaminant concentration sub-stage is configured to:
receive fluid through at least one contamination concentration sub-stage inlet of that contaminant concentration sub-stage;
output from its first outlet a respective first portion comprising a first concentration of the first contaminant; and
output from its second outlet a respective second portion comprising a second concentration of the first contaminant, the respective first concentration of the first contaminant greater than the respective second concentration of the first contaminant;
each PCD sub-stage comprises a respective PCD vessel and a respective photocatalyst in the respective PCD vessel,
each PCD vessel comprises a respective PCD-vessel inlet,
each PCD sub-stage comprises a respective PCD-sub-stage outlet,
for each stage, the respective first outlet of the contaminant concentration sub-stage is fluid-flow connected to the respective PCD-vessel inlet for that stage, and
each separation-stage-contaminant-fraction outlet is fluid-flow connected to the first inlet of a respective one of the contaminant concentration-sub-stages.

60. The system recited in claim 59, wherein:
each of the second outlets of the contaminant concentration sub-stages is fluid-flow connected to a separation-stage inlet of the first serial-separation stage, and
each of the PCD-sub-stage outlets is fluid-flow connected to a separation-stage inlet of the first serial-separation stage.

61. The system recited in claim 59, wherein each of the respective second outlets of the contaminant concentration sub-stages is fluid-flow connected to a separation-stage inlet of the first serial-separation stage.

62. The system recited in claim 61, wherein for each of the series of stages except for the last stage, the PCD-sub-stage outlet for that stage is fluid-flow connected to a contaminant-concentration-sub-stage inlet for a stage that is next in the series of stages.

63. The system recited in claim 62, wherein the sequence of separation-stage fractionation columns in the first series of separation-stage fractionation columns corresponds to the sequence of stages.

64. The system recited in claim 62, wherein:
the first series of separation-stage fractionation columns comprises the first separation-stage fractionation column and at least a second separation-stage fractionation column,
the series of stages comprises the first stage and at least a second stage,
the contamination-fraction outlet from the first separation-stage fractionation column is fluid-flow connected to a contamination-concentration sub-stage inlet of the first stage, and
the contamination-fraction outlet from the second separation-stage fractionation column and the PCD outlet from the first stage are fluid-flow connected to a contamination-concentration-sub-stage inlet of the second stage.

65. The system recited in claim 62, wherein:
the first series of separation-stage fractionation columns comprises the first separation-stage fractionation column and at least second and third separation-stage fractionation columns,
the series of stages comprises the first stage and at least second and third stages,
the contamination-fraction outlet from the first separation-stage fractionation column is fluid-flow connected to a contaminant-concentration-sub-stage inlet to the first stage,
the contamination-fraction outlet from the second separation-stage fractionation column and the PCD-sub-stage outlet from the first stage are fluid-flow connected to a contaminant-concentration-sub-stage inlet to the second stage, and
the contamination-fraction outlet from the third separation-stage fractionation column and the PCD-sub-stage outlet from the second stage are fluid-flow connected to a contaminant-concentration-sub-stage inlet to the third stage.

66. The system recited in claim 59, wherein for each of the series of stages except for the last stage, the PCD-sub-stage outlet for that stage is fluid-flow connected to a contaminant-concentration-sub-stage inlet for a stage that is next in the series of stages.

67. A method of treating a fluid containing contaminant, the method comprising:
supplying the fluid to a first contaminant concentration sub-stage of a first stage of a system, the first stage comprising the first contaminant concentration sub-stage and a first PCD sub-stage, the first PCD sub-stage comprising a first PCD vessel and a first PCD photocatalyst, the first PCD photocatalyst is in the first PCD vessel;
outputting from a first-contaminant-concentration-sub-stage first outlet a first-stage first portion comprising a first-stage first concentration of the first contaminant;
outputting from a first-contaminant-concentration-sub-stage second outlet a first-stage second portion comprising a first-stage second concentration of the first contaminant, the first-stage first concentration of the first contaminant greater than the first-stage second concentration of the first contaminant;
supplying the first-stage first portion to the first PCD vessel; and
directing electromagnetic radiation at the first PCD vessel.

68-132. (canceled)

133. A system for administering PCD to a fluid, the system comprising:
a PCD vessel;
a PCD photocatalyst, the PCD photocatalyst is in the PCD vessel;
a lamp configured to emit photons of at least one wavelength that, upon being absorbed by the PCD photocatalyst, causes the PCD photocatalyst to generate photo-induced electron and hole pairs; and
the PCD photocatalyst comprising epitaxial hexagonal boron nitride/boron nitride nanotube.

134. (canceled)

135. A method for administering PCD to a fluid, the method comprising:
directing electromagnetic radiation at a PCD vessel, the PCD vessel containing the fluid and a PCD photocatalyst, causing the PCD photocatalyst to absorb photons and generate photo-induced electron and hole pairs, and
the PCD photocatalyst comprising epitaxial hexagonal boron nitride/boron nitride nanotube.

136. (canceled)

137. A method for administering PCD to a fluid, the method comprising:
continuously supplying fluid to a PCD vessel for at least a first period of time, the PCD vessel containing a PCD photocatalyst;
directing electromagnetic radiation at the PCD vessel, causing the PCD photocatalyst to absorb photons and generate photo-induced electron and hole pairs; and
continuously removing fluid from the PCD vessel during the first period of time.

138-139. (canceled)
